(19) United States
(12) Patent Application Publication
(10) Pub. No.: US 2004/0027923 A1
(43) Pub. Date: Feb. 12, 2004

(54) Analog electronic timepiece having train wheel setting lever

(76) Inventors: Tamotsu Ono, Chiba-shi (JP); Mamoru Watanabe, Chiba-shi (JP); Yuichi Shino, Chiba-shi (JP); Kei Hirano, Chiba-shi (JP)

Correspondence Address: ADAMS & WILKS, 31st Floor, 50 Broadway, New York, NY, 10004, US

(21) Appl. No.: 10/463,681

(22) Filed: Jun. 17, 2003

(30) Foreign Application Priority Data
Jun. 18, 2002 (JP) 2002-176922

(51) Int. Cl. G04F 7/00

(52) U.S. Cl. 368/106

(57) ABSTRACT

To provide a small-sized and thin analog electronic timepiece having a mechanism capable of firmly setting a train wheel for rotating a small second hand. An analog electronic timepiece includes a main plate, bridge members time information indicating wheels rotated with a main plate center as rotation center, a small second wheel rotated with a position other than a center of a movement as rotation center, a hand setting stem, a switching apparatus and a dial. The analog electronic timepiece includes a reset lever constituted to be able to rotate by operating the switching apparatus when the hand setting stem is pulled out to a first stage and a train wheel setting lever constituted to linearly move based on rotation of the reset lever. In a state of pulling out the hand setting stem to the first stage, a train wheel setting lever can set rotation of the small second wheel or other wheel provided to rotate the small second wheel.

### FIELD OF THE INVENTION

The present invention relates to an analog electronic timepiece having a train wheel setting lever. Particularly, the invention relates to an analog chronograph electronic timepiece having a movement constituted to be able to arrange a chronograph second hand at a center of a movement and to be able to arrange the chronograph second hand at a position other than the center of the movement in an analog electronic timepiece in which the movement includes a train wheel setting lever. Further, the invention relates to an analog electronic timepiece having a movement including a motor and a train wheel for operating a small second hand in which the movement includes the train wheel setting lever.

### DESCRIPTION OF THE PRIOR ART

Generally, a movement (machine body including a drive portion) of an analog electronic timepiece includes a main plate constituting a base plate of the movement. In an analog electronic timepiece in both sides of the main plate, a side having a dial is referred to as “back side” and a side thereof opposed to the side having the dial is referred to as “surface side” of the movement. A train wheel integrated to “surface side” of the movement is referred to as “surface train wheel” and a train wheel integrated to “back side” of the movement is referred to as “back train wheel”.

The “surface side” of the movement is arranged with a battery, a circuit block, a motor, the surface train wheel and the like. Generally, the surface train wheel includes a fifth wheel & pinion, a second wheel & pinion, a third wheel & pinion and a center wheel & pinion (minute wheel & pinion) and the like. Generally, the motor is constituted by a step motor and includes a coil block, a stator and a rotor. In the analog electronic timepiece, the train wheel is rotated by driving the rotor. The rotor includes a rotor magnet and a rotor pinion (indicating a portion other than the rotor magnet in the rotor, the same as follows).

The “back side” of the movement is arranged with the back train wheel and the like. Generally, the back train wheel includes a setting wheel, an hour wheel, a minute wheel and the like. Further, a switching apparatus is arranged at the “surface side” or the “back side” of the movement. Generally, the switching apparatus includes a setting lever, a yoke, a yoke holder and the like. Further, as a hand setting mechanism, a hand setting stem, a clutch wheel, a setting wheel and the like are provided. The analog electronic timepiece is constituted such that when the step motor is operated, the train wheel is rotated by rotation of the rotor, “hour” of current time is indicated by an hour hand and “minute” of current time is indicated by a minute hand.

Further, an analog chronograph timepiece is constituted such that when the step motor is operated, the train wheel is rotated by rotation of the rotor, “second in elapse time” is indicated by a chronograph second hand, “minute in elapse time” is indicated by a chronograph minute hand, “second in elapse time” is indicated by a chronograph second hand and “hour in elapse time” is indicated by a chronograph hour hand. Further, there is also known an analog chronograph timepiece in which “time measured by a unit of one tenth second in elapse time” is indicated by one tenth chronograph second hand and/or “time measured by a unit of one fifth second in elapse time” is indicated by a one fifth chronograph second hand.

An electronic timepiece disclosed in JP-A-63-149586 is arranged with a motor and a train wheel for indicating time at a central portion of a movement and arranged with a motor and a train wheel for operating a five hundredth chronograph secondhand, a motor and a train wheel for operating a chronograph second hand and a motor and a train wheel for operating a chronograph minute hand at an outer peripheral portion of the movement at intervals of about 90 degrees.

According to an electronic timepiece with chronograph disclosed in JP-A-61-83992, a second hand arranged with a rotation center at a central portion of a movement is made to indicate normal time and chronograph time by operating an outside operating member. Further, a train wheel for driving a second hand is constituted to operate a chronograph minute hand and a chronograph hour hand.

A chronograph timepiece disclosed in JP-A-55-160890 is provided with a chronograph second hand arranged with a rotation center thereof at a central portion of a movement, a chronograph minute hand arranged with a rotation center thereof in a 9 o'clock direction of a dial and a chronograph hour hand arranged with a rotation center thereof in a 12 o'clock direction of the dial. Further, and a motor and a wheel train for operating the chronograph second hand, a motor and a train wheel for operating the chronograph minute hand and a motor and train wheel for operating the chronograph hour hand are arranged at an outer peripheral portion of the movement.

A chronograph timepiece disclosed in JP-A-55-7662 is provided with a timepiece mechanism for operating an indicator for indicating time and a chronograph mechanism for operating a chronograph hand. According to the chronograph timepiece, a rotation center of a chronograph second hand is arranged at a central portion of a movement and a rotation center of a second hand for timepiece is arranged at a middle of the central portion and an outer peripheral portion of the movement.

The conventional analog electronic timepiece arranged with a small second hand at a position other than a center of the movement poses a problem that it is difficult to arrange a train wheel setting lever for setting a train wheel for operating the small second hand at inside of the movement.

Further, particularly, in the case of the conventional analog chronograph timepiece, according to a chronograph timepiece having a structure arranged with a chronograph second hand at a center of a movement (hereinafter, referred to as “center chronograph timepiece”) and a chronograph timepiece having a structure arranged with a chronograph second hand at a position other than the center of the movement (hereinafter, referred to as “side chronograph timepiece”, dimensions, shapes and arrangements of parts constituting the respective movements, particularly, main plates, bridge members (train wheel bridges or the like), step motors and train wheels are quite different from each other.

Therefore, according to the conventional analog chronograph timepiece, when the “center chronograph timepiece” and the “side chronograph timepiece” are fabricated, the respective movements need to design quite separately from each other and the respective movements need to fabricate by quite separate steps. Therefore, train wheel setting levers need to design quite separately for the respective movements to thereby pose a problem that steps of fabricating the movements become complicated and numbers of steps of fabricating the movements are increased.

### SUMMARY OF THE INVENTION

An object of the invention is to provide a small-sized and thin analog electronic timepiece having a small second hand having a rotation center thereof at a position other than a center of a movement and having a mechanism capable of firmly setting a train wheel for rotating the small second hand.

Other object of the invention is to provide a small-sized and thin analog electronic timepiece having a mechanism capable of firmly setting a train wheel for rotating a small second hand in a structure constituted to be able to arrange a chronograph second hand at a center of a movement and to be able to arrange a chronograph second hand at a position other than the center of the movement and arranged with the small second hand at a position other than the center of the movement particularly in an analog chronograph timepiece.

The invention is characterized in an analog electronic timepiece including a main plate constituting a base plate of a movement, a bridge member for supporting a part constituting the movement, a time information indicating wheel rotated with a main plate center of the main plate as a rotation center for indicating time information, a small second wheel rotated with a position other than a center of the movement as a rotation center, a hand setting stem for correcting to indicate the time information, a switching apparatus for switching a position of the hand setting stem and a dial for indicating the time information, including a reset lever constituted to be able to rotate by operating the switching apparatus when the hand setting stem is pulled out from a zero stage to a first stage, and a train wheel setting lever constituted to linearly move based on rotation of the reset lever when the hand setting stem is pulled out from the zero stage to the first stage, wherein the train wheel setting lever is constituted to be able to set rotation of the small second wheel or other wheel provided to rotate the small second wheel.

According to the constitution, the train wheel setting lever is linearly moved and therefore; a setting portion of the train wheel setting lever is brought into contact with a wheel to be set by being operated from a direction orthogonal to the wheel. Therefore, when the train wheel setting lever sets the wheel to be set, there is rarely a concern of rotating the wheel to be set by the train wheel setting lever.

According to the analog electronic timepiece of the invention, the train wheel setting lever can be arranged not to overlap a part attached with a hand, that is, the time information indicating wheel and the small second wheel. According to the constitution, since the train wheel setting lever is arranged not to overlap the part attached with the hand and therefore a thickness of the electronic timepiece can be thinned.

Further, according to the analog electronic timepiece of the invention, the train wheel setting lever can also be arranged to overlap the small second wheel. According to the constitution, the train wheel setting lever is arranged to overlap the small second wheel and therefore, the size of the electronic timepiece can be reduced.

According to the analog electronic timepiece of the invention, it is preferable that the reset lever includes a reset conduction spring for carrying out a resetting operation, a train wheel setting lever holding portion for holding the train wheel setting lever and an operation spring for operating the train wheel setting lever. According to the constitution, the resetting operation and the setting operation can firmly be carried out by the two parts.

It is preferable for the analog electronic timepiece of the invention that a main plate reference vertical axis line passing the main plate center and in parallel with a center axis line of the hand setting stem and a main plate reference horizontal axis line passing the main plate center and orthogonal to the main plate reference vertical axis line are defined at the main plate, wherein the main plate is provided with a first region disposed on one side of the main plate reference vertical axis line and on a side of the main plate reference horizontal axis line proximate to the hand setting stem, the main plate is provided with a second region disposed on other side of the main plate reference vertical axis line and on the side of the main plate reference horizontal axis line proximate to the hand setting stem, the main plate is provided with a third region disposed on the other side of the main plate reference vertical axis line on which the second region is present and on a side of the main plate reference horizontal axis line remote from the hand setting stem and the main plate is provided with a fourth region disposed on the one side of the main plate reference vertical axis line on which the first region is present and on the side of the main plate reference horizontal axis line remote from the hand setting stem, a rotation center of the small second wheel is arranged at a position above the main plate reference horizontal axis line, above a boundary between the first region and the fourth region and between the main plate center and an outer shape portion of the main plate, a rotation center of the reset lever is arranged at the second region, portions of the train wheel setting lever and the reset lever which are brought into contact with each other are arranged at the first region, and a portion of a setting portion of the train wheel setting lever to be brought into contact with a wheel to be set is arranged at the fourth region. By the constitution, the small-sized and thin analog electronic timepiece having the train wheel setting lever operated firmly can be realized.

Further, according to the invention, it is preferable for the analog electronic timepiece that the train wheel setting lever includes two of guide window portions, the main plate includes two of guide pins for guiding the train wheel setting lever, the guide window portions of the train wheel setting lever are respectively constituted to be guided by the guide pins of the main plate, the train wheel setting lever is integrated to the main plate to be able to move linearly relative to the main plate and one of the guide pins is arranged at the first region and other thereof is arranged at the fourth region.

Further, the invention is characterized in an analog electronic timepiece, wherein the main plate includes bearing portions of a rotor and a train wheel used for fabricating a “center chronograph timepiece” by using the movement and bearing portions of a rotor and a train wheel used in fabricating a “side chronograph timepiece” by using the movement, the bridge member includes bearing portions of the rotor and the train wheel used in fabricating the “center chronograph timepiece” by using the movement and bearing portions of the rotor and the train wheel used in fabricating the “side chronograph timepiece” by using the movement, the rotor and the train wheel used in fabricating the “center chronograph timepiece” are integrated to be able to rotate relative to the bearing portions of the main plate and the bearing portions of the bridge member, the time information is constituted to indicate by a time indicating member rotated with the main plate center as a rotation center and other time indicating member rotated with a position between the main plate center and an outer shape portion of the main plate (102) as a rotation center, a measurement result of a chronograph is constituted to indicate by a chronograph indicating member rotated with the main plate center as a rotation center and other chronograph indicating member rotated with a position between the main plate center and the outer shape portion of the main plate as a rotation center, including a reset lever constituted to be able to rotate by operating the switching apparatus when the hand setting stem is pulled out from a zero stage to a first stage, and a train wheel setting lever constituted to move linearly based on rotation of the reset lever when the hand setting stem is pulled out from the zero stage to the first stage, the train wheel setting lever is constituted to be able to set rotation of a wheel in a train wheel provided for rotating the other time indicating member.

It is preferable for the analog electronic timepiece of the invention that the train wheel setting lever includes two of guide window portions, the main plate includes two of guide pins for guiding the train wheel setting lever, the guide window portions of the train wheel setting lever are respectively constituted to be guided by the guide pins of the main plate, the train wheel setting lever is integrated to the main plate to be able to move linearly relative to the main plate and one of the guide pins is arranged at the first region and other thereof is arranged at the fourth region.

### BRIEF DESCRIPTION OF THE SEVERAL VIEWS OF THE DRAWINGS

A preferred form of the present invention is illustrated in the accompanying drawings in which:

FIG. 1 is a plane view showing an outline shape by viewing a movement of a side chronograph timepiece from a surface side according to an embodiment of an analog electronic timepiece of the invention (in FIG. 1, illustration of portions of parts are omitted and bridge members are indicated by imaginary lines);

FIG. 2 is an outline partial sectional view showing a motor and a portion of a train wheel of the movement of the side chronograph timepiece according to the embodiment of the analog electronic timepiece of the invention;

FIG. 3 is an outline partial sectional view showing a battery and a portion of the train wheel of the movement of the side chronograph timepiece according to the embodiment of the analog electronic timepiece of the invention;

FIG. 4 is a plane view showing an outline shape by viewing a main plate from a surface side according to the embodiment of the analog electronic timepiece of the invention (in FIG. 4, illustration of a shape of a portion of the main plate is omitted;

FIG. 5 is a plane view showing an outline shape by viewing a train wheel bridge (A) and a train wheel bridge (B) from a surface side according to the embodiment of the chronograph timepiece of the invention (in FIG. 5, illustration of shape of portions of the train wheel bridge (A) and the train wheel bridge (B) is omitted);

FIG. 6 is a plane view showing an outline shape by viewing a back train wheel bridge from a back side (a side of the main plate) according to the embodiment of the analog electronic timepiece of the invention (in FIG. 6, illustration of a shape of a portion of the back train wheel bridge is omitted);

FIG. 7 is a block diagram of the motor and the train wheel bridge of the movement of the side chronograph timepiece according to the embodiment of the analog electronic timepiece of the invention;

FIG. 8 is a plane view showing an outline shape of a complete of the side chronograph timepiece according to the embodiment of the analog electronic timepiece of the invention;

FIG. 9 is a plane view showing an outline shape by viewing a movement of a center chronograph timepiece from a surface side according to an embodiment of an analog electronic timepiece of the invention (in FIG. 9, portions of parts are omitted);

FIG. 10 is an outline partial sectional view showing a motor and a portion of a train wheel of a movement of the center chronograph timepiece according to the embodiment of the analog electronic timepiece of the invention;

FIG. 11 is an outline partial sectional view showing a battery and a portion of the train wheel of the movement of the center chronograph timepiece according to the embodiment of the analog electronic timepiece of the invention;

FIG. 12 is a block diagram of the motor and the train wheel of the movement of the center chronograph timepiece according to the embodiment of the analog electronic timepiece of the invention;

FIG. 13 is a plane view showing an outline shape of a complete of the center chronograph timepiece according to the embodiment of the analog electronic timepiece of the invention;

FIG. 14 is a plane view showing an outline arrangement of the motor and the train wheel of the movement of the side chronograph timepiece according to the embodiment of the analog electronic timepiece of the invention (in FIG. 14, illustration of portions of parts is omitted);

FIG. 15 is a plane view showing an outline arrangement of a motor and a train wheel of a movement of a side chronograph timepiece according to other embodiment of an analog electronic timepiece of the invention (in FIG. 15, illustration of portions of parts are omitted);

FIG. 16 is a plane view showing an outline arrangement of a motor and a train wheel in the movement of the center chronograph timepiece according to the embodiment of the analog electronic timepiece of the invention (in FIG. 16, illustration of portions of parts is omitted);

FIG. 17 is a plane view showing an outline arrangement of a motor and a train wheel in a movement of a center chronograph timepiece according to other embodiment of an analog electronic timepiece of the invention (in FIG. 17, illustration of portions of parts is omitted);

FIG. 18 is a plane view showing an outline arrangement of a first type of a train wheel setting lever and a time indicating train wheel in the movement of a side chronograph timepiece according to an embodiment of an analog electronic timepiece of the invention (in FIG. 18, illustration of portions of parts is omitted);

FIG. 19 is a partial sectional view showing an outline structure of the first type of the train wheel setting lever, a hand setting stem and a reset lever in the movement of the side chronograph timepiece according to the embodiment of the analog electronic timepiece of the invention;

FIG. 20 is a partial sectional view showing an outline structure of the first type of the train wheel setting lever, the reset lever and an intermediate small second wheel (B) in the movement of the side chronograph timepiece according to the embodiment of the analog electronic timepiece of the invention;

FIG. 21 is a partial sectional view showing an outline structure of a setting lever, a minute wheel, the reset lever and a ⅕ CG intermediate wheel (B) in the movement of the side chronograph timepiece according to the embodiment of the analog electronic timepiece of the invention;

FIG. 22 is a plane view showing an outline arrangement of a second type of a train wheel setting lever and a time indicating train wheel in a movement of a side chronograph timepiece according to an embodiment of the analog electronic timepiece of the invention (in FIG. 22, illustration of portions of parts is omitted);

FIG. 23 is a plane view showing an outline arrangement of a third type of a train wheel setting lever and a time indicating train wheel in a movement of a side chronograph timepiece according to an embodiment of the analog electronic timepiece of the invention (in FIG. 23, illustration of portions of parts is omitted); and

FIG. 24 is a plane view showing an outline arrangement of a fourth type of a train resetting lever and a time indicating train wheel in a movement of a side chronograph timepiece according to an embodiment of the analog electronic timepiece of the invention (in FIG. 24, illustration of portions of parts is omitted).

### DETAILED DESCRIPTION OF THE PREFERRED EMBODIMENTS

A mode for carrying out the invention will be explained as follows.

(1) First Embodiment

A first embodiment of an analog electronic timepiece according to the invention will be explained as follows. The first embodiment of the invention is a “side chronograph timepiece” of a center three hands type, that is, an analog chronograph timepiece having a structure arranged with a chronograph second hand at a position other than a center of a movement and arranged with a second hand indicating time at the center of the movement.

(1•1) Total Constitution of Movement and Definition of Technical Term

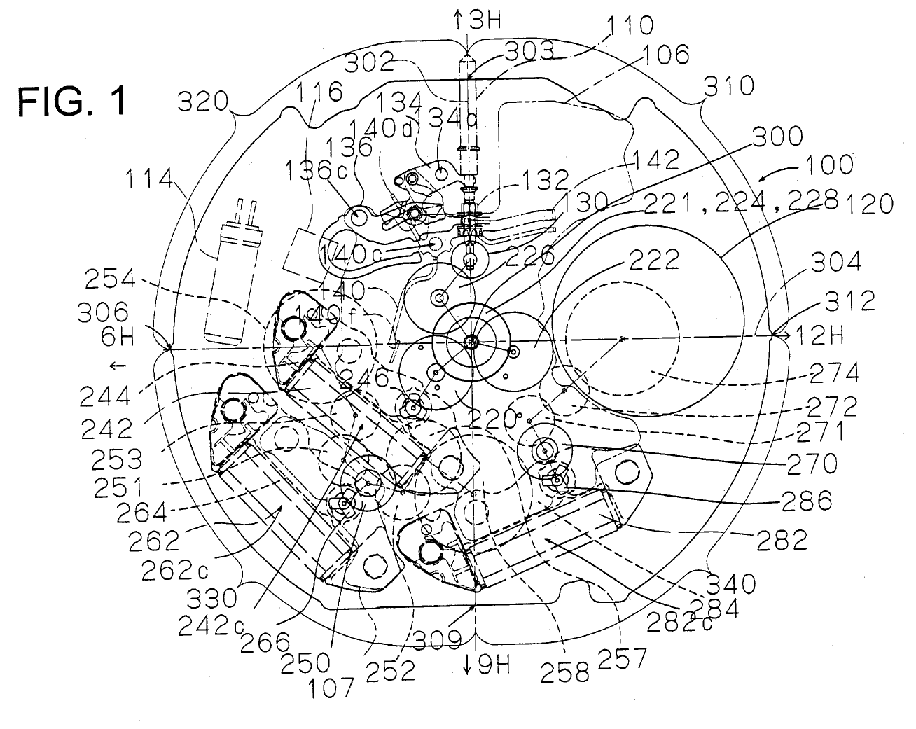

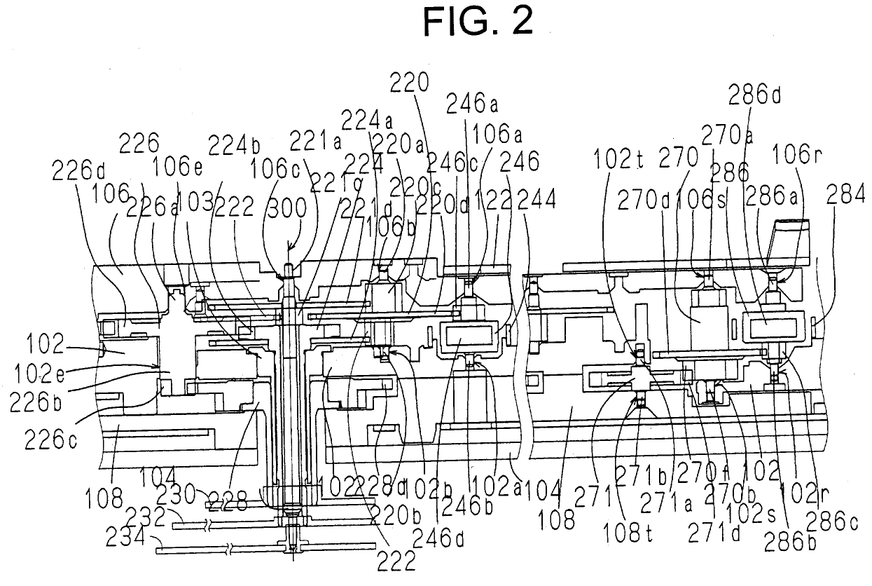

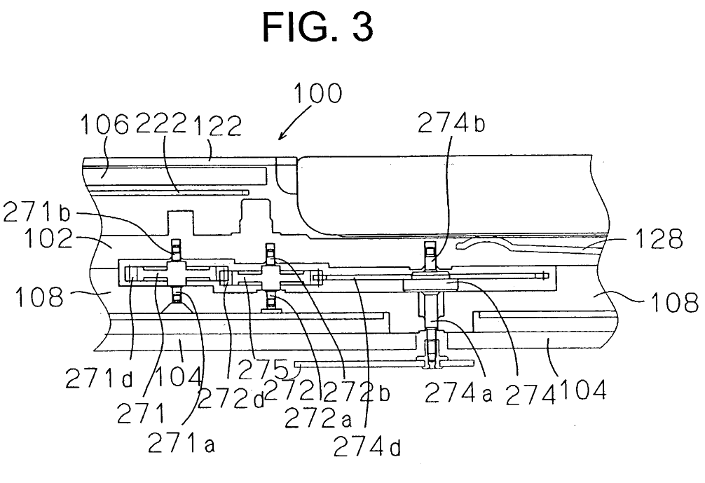

First, a total constitution of a movement of an analog chronograph timepiece according to the invention will be explained. In reference to FIG. 1 through FIG. 3, an analog chronograph timepiece according to the invention is provided with a movement 100. The movement 100 includes a main plate 102 constituting a base plate thereof. According to the embodiment of the invention, an outer shape of the main plate 102 is substantially circular. Further, the outer shape of the main plate 102 may be other shape of a quadrangular shape, a polygonal shape, an elliptical shape or the like. It is preferable that the outer shape of the main plate 102 is a circular shape in which a portion of the outer shape is cut as shown by FIG. 1.

According to the Embodiment of the invention, a motor, a surface train wheel portion (including a motor for driving a surface train wheel and a surface train wheel), a battery, a circuit block, and a switching apparatus are arranged in the movement 100 on a side opposed to a side having a dial 104 with the main plate 102 as a reference, that is, on a surface side of the movement 102 (main plate 102). A back train wheel bridge 108 is arranged on the side having the dial 104 with the main plate 102 as a reference.

The switching apparatus includes a hand setting stem 110 for correcting time information, a clutch wheel 132 capable of rotating a setting wheel 130 by rotation of the hand setting stem 110, a setting lever 134 and a yoke 136. The movement 100 is formed with an irregular portion of the yoke 136 to be able to pull the hand setting stem 110 to a first stage. By spring force of a spring portion of the yoke 136, the irregular portion of the yoke 136 is pressed to a side face of a front end portion of the setting lever 134. By the constitution, a position of the setting lever 134 is determined, further, setting weight of the hand setting stem 110 is set.

According to an analog chronograph timepiece, in assuming a state of attaching the dial 104 to the movement 100, a direction directed from a center 300 of the movement 100 to a 12 o'clock graduation of the dial 104 is referred to as “12 o'clock direction” (indicated as “12H” in FIG. 1), a direction directed from the center 300 of the movement 100 to a 3 o'clock graduation of the dial is referred to as a “3 o'clock direction” (indicated in FIG. 1 as “3H”), a direction directed from the center 300 of the movement 100 to a 6 o'clock graduation of the dial is referred to as “6 o'clock direction” (indicated in FIG. 1 as “6H”) and a direction directed from the center 300 of the movement 100 to a 9'clock graduation of the dial is referred to as “9 o'clock direction” (indicated in FIG. 1 as “9H”).

The hand setting stem 110 is rotatably integrated to the main plate 102. A rotation axis line of the hand setting stem 110 is arranged to coincide with a straight line directed from the center 300 of the movement 100 to “3 o'clock direction”.

In FIG. 1, at the main plate 102, a main plate reference vertical axis line 302 passing a rotation center 300 (hereinafter, referred to as “main plate center 300”)) of a center wheel & pinion for side 224 and in parallel with a center axis line of the hand setting stem 110 and a main plate reference horizontal axis line 304 passing the main plate center 300 and orthogonal to the main plate reference vertical axis line 302 are defined. At the main plate 102, a first region 310 is provided to dispose at a position on one side of the main plate reference vertical axis line 302 and on a side of the main plate reference horizontal axis line 304 proximate to the hand setting stem 110. At the main plate 102, a second region 320 is provided to dispose at a position on other side of the main plate reference vertical axis line 302 and on the side of the main plate reference horizontal axis line 304 proximate to the hand setting stem 110. At the main plate 102, a third region 330 is provided to dispose at a position on the other side of the main plate reference vertical axis line 302 where the second region 320 is present and on a side of the main plate reference horizontal axis line 304 remote from the hand setting stem 110. At the main plate 102, a fourth region 340 is provided to dispose at a position on the one side of the main plate reference vertical axis line 302 where the first region is present and on the side of the main plate reference horizontal axis line 304 remote from the hand setting stem 110.

Although in FIG. 1, the first region 310 and the fourth region 340 are defined on the right side of the main plate reference vertical axis line 302, as a modified examples the first region 310 and the fourth region 340 may be defined to dispose on the left side of the main plate reference vertical axis line 302. In this case, the second region 320 and the third region 330 are defined to dispose on the right side of the main plate reference vertical axis line 302.

(1•2) Constitution of Train Wheel Portion for Indicating Time

Next, a constitution of a train wheel portion for indicating time will be explained. The train wheel portion for indicating time includes a train wheel driving motor for indicating time and a train wheel for indicating time.

In reference to FIG. 1 through FIG. 3, “surface side” of the movement 100 is arranged with a circuit block, a battery 120, a surface train wheel portion for side, a chronograph minute/second train wheel portion, a 1/10 second train wheel portion, a switching apparatus and so on. The main plate 102, a train wheel bridge (A) 106 and a train wheel bridge (B) 107 constitute support members. A center pipe 103 is fixed to the main plate 102 with the main plate center 300 as a center axis. A center wheel & pinion for side 224 is rotatably integrated to a center hole of the center pipe 103. The center wheel & pinion for side 224 includes a center wheel for side 224a and a cannon pinion for side 224b. The center wheel for side 224a is integrated to the cannon pinion for side 224b slippably relative to the cannon pinion for side 224b. An outer periphery of a cylindrical portion of the cannon pinion for side 224b is rotatably integrated to the center hole of the center pipe 103. The center wheel for side 224a is disposed between the main plate 102 and the train wheel bridge 106. The center wheel for side 224a is constituted to rotate integrally with the cannon pinion for side 224b.

A surface train wheel portion for side includes a surface wheel train driving motor for side, that is, a time motor for side and an hour indicating train wheel for side. By rotation of the time motor for side, the hour indicating train wheel for side is rotated, “hour”, in current time is constituted to indicate by an hour hand 230, “minute” in current time is constituted to indicate by a minute hand 232 and “second” in current time is constituted to indicate by a second hand 234.

A crystal unit 114 and IC (integrated circuit) 116 are attached to a circuit block (not illustrated). The circuit block is fixed to the main plate 102, the train wheel bridge (A) 106 and the train wheel bridge (B) 107 by a switch spring 122 via an insulating plate (not illustrated). The battery 120 is constituted by a silver battery, a lithium battery or the like to constitute a power source of the analog chronograph timepiece. As the power source of the analog chronograph timepiece, a chargeable secondary battery may be used or a chargeable capacitor may be used. A crystal oscillator in the crystal unit 114 constitutes an oscillation source of the analog chronograph timepiece and is oscillated at, for example, 32,768 Herz. A battery minus terminal 128 is constituted to conduct a cathode of the battery 120 and a minus input portion of IC 116 via a minus pattern of the circuit block. In a time indicating mode, IC (Integrated Circuit) 116 is constituted to measure current time and operate the time motor for side.

The time motor for side includes a time coil block for side 242, a time stator for side 244 and a time rotor for side, that is, a time rotor (A) 246. When a time motor drive signal outputted by IC (Integrated Circuit) 116 is inputted to the time coil block 242, the time stator for side 244 is magnetized to rotate the time rotor (A) 246. The time rotor (A) 246 is constituted to rotate by, for example, 180 degrees per second. The time rotor (A) 246 includes an upper shaft portion 246a, a lower shaft portion 246b, a pinion portion 246c and a rotor magnet 246d. The upper shaft portion 246a of the time rotor (A) 246 is rotatably integrated to a time rotor (A) upper bearing portion 106a provided at the train wheel bridge (A) 106. The lower shaft portion 246b of the time rotor (A) 246 is rotatably integrated to a time rotor (A) lower bearing portion 102a provided at the main plate 102. Therefore, the time rotor (A) 246 is rotatably arranged between the train wheel bridge (A) 106 and the main plate 102. Based on rotation of the time rotor (A) 246, a second wheel & pinion for side 221 is constituted to rotate via rotation of a time fifth wheel & pinion for side, that is, a time fifth wheel & pinion (A) 220. The time fifth wheel & pinion 220 includes an upper shaft portion 220a, lower shaft portion 220b, a pinion portion 220c and a wheel portion 220d. The wheel portion 220d of the time fifth wheel & pinion (A) 220 is constituted to be brought in mesh with the pinion portion 246c of the time rotor (A) 246. The upper shaft portion 220a of the time fifth wheel & pinion (A) 220 is rotatably integrated to a time fifth wheel & pinion (A) upper bearing portion 106b provided at the main wheel bridge (A) 106. The lower shaft portion 220b of the time fifth wheel & pinion (A) 220 is rotatably integrated to a time fifth wheel & pinion (A) lower bearing portion 102b. Therefore, the time fifth wheel & pinion (A) 220 is rotatably arranged between the train wheel bridge (A) 106 and the main plate 102.

The second wheel & pinion for side 221 includes an upper shaft portion 221a, an abacus bead portion 221b, a pinion portion 221c and a wheel portion 221d. The wheel portion 221d of the second wheel & pinion fourth side 221 is constituted to be brought in mesh with the pinion portion 220c of the time fifth wheel & pinion (A) 220. The upper shaft portion 221a of the second wheel & pinion fourth side 221 is rotatably integrated to a side second wheel & pinion upper shaft portion 106c provided at the train wheel bridge (A) 106. The abacus bead portion 221b of the second wheel & pinion for side 221 is rotatably arranged to inside of the center hole of the cannon pinion for side 224b. Rotation center of the second wheel & pinion for side 221 is the main plate center 300. The second wheel & pinion for side 221 is constituted to rotate by one rotation per minute. The second hand 234 is attached to the second wheel & pinion for 221. The second hand 234 constitutes a second indicating member. As the second indicating member, the second hand may be used, a circular disk may be set or an indicating member of other shape including flower or geometrical shape may be used.

A side second wheel & pinion holder spring 231 is provided to exert press force to the second wheel & pinion for side 221.

Based on rotation of the second wheel & pinion for side 221, the center wheel & pinion for side 224 is constituted to rotate via rotation of a third wheel & pinion for side 222. The third wheel & pinion for side 222 includes an upper shaft portion, a lower shaft portion, a pinion portion 222c and a wheel portion 222d. The wheel portion 222d of the third wheel & pinion for side 222 is constituted to be brought in mesh with the pinion portion 221c of the second wheel & pinion for side 221. The upper shaft portion of the third wheel & pinion for side 222 is rotatably integrated to a side third wheel & pinion upper bearing portion 106d (refer to a view of the train wheel bridge (A) 106 mentioned later) provided at the train wheel bridge (A) 106. The lower shaft portion of the third wheel & pinion for side 222 is rotatably integrated to a side third wheel & pinion lower bearing portion 102d (refer to a view of the main plate, mentioned later) provided at the main plate 102. Therefore, the third wheel & pinion for side 222 is rotatably arranged between the train wheel bridge (A) 106 and the main plate 102. The center wheel & pinion for side 224 is constituted to rotate by one rotation per hour. The minute hand 232 is attached to the cannon pinion for side 224b of the center wheel & pinion for side 224. The minute hand 232 constitutes a minute indicating member. As a minute indicating member, the minute hand may be used, a circular disk may be used or an indicating member of other shape including flowing or geometrical shape may be used.

Based on rotation of the center wheel & pinion for side 224, an hour wheel 228 is constituted to rotate via rotation of a minute wheel 226. The minute wheel 226 includes an upper shaft portion 226a, a lower shaft portion 226b, a pinion portion 226c and a wheel portion 226d. The wheel portion 226d of the minute wheel 226 is constituted to be brought in mesh with a pinion portion of the cannon pinion for side 224b of the second wheel & pinion for side 221. The upper shaft portion 226a of the minute wheel 226 is rotatably integrated to a minute wheel upper bearing portion 106e provided at the train wheel bridge (A) 106. The lower shaft portion 226b of the minute wheel 226 is rotatably integrated to a minute wheel lower bearing portion 102e provided at the main plate 102. The wheel portion 226d of the minute wheel 226 is rotatably arranged between the train wheel bridge (A) 106 and the main plate 102. The pinion portion 226c of the minute wheel 226 is rotatably arranged between the main plate 102 and the back train wheel bridge 108. The hour wheel 228 is rotatably integrated to an outer peripheral portion of the center pipe 103. An hour wheel wheel portion 228d of the hour wheel 228 is rotatably arranged between the main plate 102 and the back train wheel bridge 108. Rotation center of the hour wheel 228 is the main plate center 300. Therefore, rotation center of the hour wheel 228 and rotation center of the center wheel & pinion for side 221 are disposed at a position the same as that of the rotation center of the center wheel & pinion for side 224. The hour wheel 228 is constituted to rotate by one rotation per 12 hours. The hour hand 234 is attached to the hour wheel 228. The hour hand 234 constitutes an hour indicating member. As the hour indicating member, the hour hand may be used, a circular disk may be used or an indicating member of other shape including flower or geometrical shape may be used.

When the hand setting stem 110 is rotated in the state of pulling out the hand setting stem 110 to the first stage, the clutch wheel 132 is rotated and the setting wheel 130 is constituted to be able to rotate by rotation of the clutch wheel 132. Further, time is constituted to be able to set by rotating the hour wheel 226 by the setting wheel 130. A reset lever 140 includes a reset conduction spring 140d and a train wheel setting portion 140f. In the state of pulling out the hand setting stem 110 to the first stage, the train wheel setting portion 140f of the reset lever 140 is constituted to be able to set rotation of the time fifth wheel & pinion (A) 220. In the state of putting out the hand setting stem 110 to the first stage, by conducting the reset conduction spring 140d to a reset pattern of the circuit block, the analog chronograph timepiece is constituted to be able to reset.

(1•3) Constitution of Chronograph Minute/Second Indicating Train Wheel Portion

Next, a constitution of a chronograph minute/second indicating train wheel portion operated by a chronograph measuring mode in the analog electronic timepiece (analog chronograph timepiece) according to the invention will be explained. The chronograph minute/second indicating train wheel portion includes a motor for driving a chronograph minute/second indicating train wheel and the chronograph minute/second indicating train wheel.

In reference to FIG. 1, the chronograph minute/second indicating train wheel portion includes the motor for driving the chronograph minute/second indicating train wheel, that is, a chronograph minute/second motor and the chronograph minute/second indicating train wheel. The chronograph minute/second indicating train wheel is rotated by rotation of the chronograph minute/second motor, “chronograph minute” in elapse time measured in the chronograph measuring mode is constituted to indicate by a chronograph minute hand and “chronograph second” in the elapse time measured in the chronograph measuring mode is constituted to indicate by a chronograph second hand. In the chronograph measuring mode, IC (Integrated Circuit) 116 is constituted to measure the elapse time and operate the chronograph minute/second motor.

The chronograph minute/second motor includes a chronograph minute/second coil block 262, a chronograph minute/second stator 264 and a chronograph minute/second rotor 266. Dimensions and shape of the chronograph minute/second coil block 262 can be made the same as dimensions and shape of the time coil block for side 242. Dimensions and shape of the chronograph minute/second stator 264 can be made the same as dimensions and shape of the time stator for side 244.

When a chronograph minute/second motor drive signal outputted by IC (Integrated Circuit) 116 is inputted to the chronograph minute/second coil block 262, the chronograph minute/second stator 264 is magnetized to rotate the chronograph minute/second rotor 266. The chronograph minute/second rotor 266 is constituted to rotate by, for example, 180 degrees per second. The chronograph minute/second rotor 266 includes an upper shaft portion, a lower shaft portion, a pinion portion and a rotor magnet. The upper shaft portion of the chronograph minute/second rotor 266 is rotatably integrated to a chronograph minute/second rotor upper bearing portion 107f (refer to a view of the train wheel bridge (B) 107, mentioned later) provided at the train wheel bridge (B) 107. The lower shaft portion of the chronograph minute/second rotor 266 is rotatably integrated to a chronograph minute/second rotor lower bearing portion 102f (refer to a view of the main plate, mentioned later) provided at the main plate 102. Therefore, the chronograph minute/second rotor 266 is arranged rotatably between the train wheel bridge (B) 107 and the main plate 102.

Based on rotation of the chronograph minute/second rotor 266, a chronograph minute/second fifth wheel & pinion 250 is constituted to rotate. Based on rotation of the chronograph minute/second fifth wheel & pinion 250, a chronograph second intermediate wheel (A) 251 and a chronograph minute intermediate wheel (A) 252 are constituted to rotate. The chronograph minute/second fifth wheel & pinion 250 includes an upper shaft portion, a lower shaft portion, a pinion portion and a wheel portion. The wheel portion of the chronograph minute/second fifth wheel & pinion 250 is constituted to be brought in mesh with the pinion portion of the chronograph minute/second rotor 266. The upper shaft portion of the chronograph minute/second f if th wheel & pinion 250 is rotatably integrated to a chronograph minute/second fifth wheel & pinion upper bearing portion 107g (refer to a view of the train wheel bridge (B) 107, mentioned later) provided at the train wheel bridge (B) 107. The lower shaft portion of the chronograph minute/second fifth wheel & pinion 250 is rotatably integrated to a chronograph minute/second fifth wheel & pinion lower bearing portion 102g (refer to a view of the main plate, mentioned later) provided at the main plate 102. Therefore, the chronograph minute-second fifth wheel & pinion 250 is rotatably arranged between the train wheel bridge (B) 107 and the main plate 102.

Based on rotation of the second-counter intermediate wheel (A) 251, a second-counting wheel 254 is constituted to rotate via rotation of a second-counter intermediate wheel (B) 253. Dimensions and shape of the second-counter intermediate wheel (A) 251 are constituted to be the same as dimensions and shape of the second-counter intermediate wheel (B) 253. The second-counter intermediate wheel (A) 251 includes an upper shaft portion, a lower shaft portion and a wheel portion. The wheel portion of the second-counter intermediate wheel (A) 251 is constituted to be brought in mesh with a pinion portion of the chronograph minute/second fifth wheel & pinion 250. The upper shaft portion of the second-counter intermediate wheel (A) 251 is rotatably integrated to a second-counter intermediate wheel (A) upper bearing portion 108h (refer to a view of the back train wheel bridge, mentioned later) provided at the back train wheel bridge 108. The lower shaft portion of the second-counter intermediate wheel (A)) 251 is rotatably integrated to a second-counter intermediate wheel (A) lower bearing portion 102h (refer to a view of the main plate, mentioned later) provided at the main plate 102. Therefore, the second-counter intermediate wheel (A) 251 is rotatably arranged between the back train wheel bridge 108 and the main plate 102.

The second-counter intermediate wheel (B) 253 includes an upper shaft portion, a lower shaft portion and a wheel portion. The wheel portion of the second-counter intermediate wheel (B) 253 is constituted to be brought in mesh with the wheel portion of the second-counter intermediate wheel (A) 251. The upper shaft portion of the second-counter intermediate wheel (B) 253 is rotatably integrated to a second-counter intermediate wheel (B) upper bearing portion 108j (refer to a view of the back train wheel bridge, mentioned later) provided at the back train wheel bridge 108. The lower shaft portion of the second-counter intermediate wheel (B) 253 is rotatably integrated to a second-counter intermediate wheel (B) lower bearing portion 102j (refer to a view of the main plate, mentioned later) provided at the main plate 102. Therefore, the second-counter intermediate wheel (B) 253 is rotatably arranged between the back train wheel bridge 108 and the main plate 102.

The second-counting wheel 254 includes an upper shaft portion, a lower shaft portion and a wheel portion. The wheel portion of the second-counting wheel 254 is constituted to be brought in mesh with the wheel portion of the second-counter intermediate wheel (B) 253. The upper shaft portion of the second-counting wheel 254 is rotatably integrated to a second-counting wheel upper bearing portion 108k (refer to a view of the back train wheel bridge, mentioned later) provided at the back train wheel bridge 108. The lower shaft portion of the second-counting wheel 254 is rotatably integrated to a second-counting wheel lower bearing portion 102k (refer to a view of the main plate, mentioned later) provided at the main plate 102. Therefore, the second-counting wheel 254 is arranged rotatably between the back train wheel bridge 108 and the main plate 102. A second chronograph hand 255 (refer to a view of a complete, mentioned later) is attached to the second-counting wheel 254. The second chronograph hand 255 constitutes a second chronograph indicating member. In the chronograph measuring mode, the second chronograph hand 255 is operated to indicate “second” in elapse time.

In reference to FIG. 1, rotation center of the second-counting wheel 254 is disposed at a position above the main plate reference horizontal axis line 304 and between the main plate center 300 and an outer shape portion 306 of the main plate 102 disposed in “6 o'clock direction” of the movement 100. A distance between rotation center of the second-counting wheel 254 and the main plate center 300 is about ½ of a radius of a maximum outer shape portion of the main plate 102.

Based on rotation of the minute-counter intermediate wheel (A) 252, a minute-counting wheel 258 is constituted to rotate via rotation of a minute-counter intermediate wheel (B) 257. The minute-counter intermediate wheel (A) 252 includes an upper shaft portion, a lower shaft portion a pinion portion and a wheel portion. The wheel portion of the minute-counter intermediate wheel (A) 252 is constituted to be brought in mesh with the pinion portion of the chronograph minute/second fifth wheel & pinion 250. The upper shaft portion of the minute-counter intermediate wheel (A) 252 is rotatably integrated to a minute-counter intermediate wheel (A) upper bearing portion 108m (refer to a view of the back train wheel bridge, mentioned later) provided at the back train wheel bridge 108. The lower shaft portion of the minute-counter intermediate wheel (A) 252 is rotatably integrated to a minute-counter intermediate wheel (A) lower bearing portion 102m (refer to a view of the main plate, mentioned later) provided at the main plate 102. Therefore, the minute-counter intermediate wheel (A) 252 is rotatably arranged between the back train wheel bridge 108 and the main plate 102.

The minute-counter intermediate wheel (B) 257 includes an upper shaft portion, a lower shaft portion, a pinion portion and a wheel portion. The minute-counter intermediate wheel (B) 257 is constituted to be brought in mesh with a pinion portion of the minute-counter intermediate wheel (A) 252. The upper shaft portion of the minute-counter intermediate wheel (B) 257 is rotatably integrated to a minute-counter intermediate wheel (B) upper bearing portion 108n (refer to a view of the back train wheel bridge, mentioned later) provided at the back train wheel bridge 108. The lower shaft portion of the minute-counter intermediate wheel (B) 257 is rotatably integrated to a minute-counter intermediate wheel (B) lower bearing portion 102n (refer to a view of the main plate, mentioned later) provided at the main plate 102. Therefore, the minute-counter intermediate wheel (B) 257 is rotatably arranged between the back train wheel bridge 108 and the main plate 102.

The minute-counting wheel 258 includes an upper shaft portion, a lower shaft portion and a wheel portion. The wheel portion of the minute-counting wheel 258 is constituted to be brought in mesh with the wheel portion of the minute-counter intermediate wheel (B) 257. The upper shaft portion of the minute-counting wheel 258 is rotatably integrated to a minute-counting wheel upper bearing portion 108p (refer to a view of the back train wheel bridge, mentioned later) provided at the back train wheel bridge 108. The lower shaft portion of the minute-counting wheel 258 is rotatably integrated to a minute-counting wheel lower bearing portion 102p (refer to a view of the main plate, mentioned later) provided at the main plate 102. Therefore, the minute-counting wheel 258 is rotatable arranged between the back train wheel bridge 108 and the main plate 102. A minute chronograph hand 259 (refer to a view of a complete, mentioned later) is attached to the minute-counting wheel 258. The minute chronograph hand 259 constitutes a minute chronograph indicating member. In the chronograph measuring mode, the minute chronograph hand 259 is operated to indicate “minute” of elapse time.

In reference to FIG. 1, rotation center of the minute-counting wheel 258 is disposed above the main plate reference vertical axis line 302 and between the main plate center 300 and an outer shape portion 309 of the main plate 102 in “9 o'clock direction” of the movement 100. A distance between rotation center of the minute-counting wheel 258 and the main plate center 300 is about ½ of a radius of a maximum outer shape portion of the main plate 102.

(1•4) Constitution of 1/10 Second Indicating Train Wheel Portion

Next, an explanation will be given of a constitution of a 1/10 second indicating train wheel portion operated in the chronograph measuring mode in the analog electronic timepiece (analog chronograph timepiece) according to the invention. The 1/10 second indicating train wheel portion includes a motor for driving a 1/10 second indicating train wheel and a 1/10 second indicating train wheel.

In reference to FIG. 1 through FIG. 3, the 1/10 second motor includes a 1/10 second coil block 282, a 1/10 second stator 284 and a 1/10 second rotor 286. Dimensions and shape of the 1/10 second coil block 282 can be made the same as the dimensions and shape of the time coil block for side 242. Dimensions and shape of the 1/10 second stator 284 can be made the same as dimensions and shape of the time stator 244 for side.

When a 1/10 second motor drive signal outputted by IC (Integrated Circuit) 116 is inputted to the 1/10 second coil block 282, the 1/10 second stator 284 is magnetized to rotate the 1/10 second rotor 286. The 1/20 second rotor 286 is constituted to rotate by, for example, 180 degrees per 1/10 second. The 1/10 second rotor 286 includes an upper shaft portion 286a, a lower shaft portion 286b, a pinion portion 286c and a rotor magnet 286d. The upper shaft portion 286a of the 1/10 second rotor 286 is rotatably integrated to a 1/10 second rotor upper bearing portion 106r provided at the train wheel bridge (A) 106. The lower shaft portion 286b of the 1/10 second rotor 286 is rotatably integrated to a 1/10 second rotor lower bearing portion 102r provided at the main plate 102. Therefore, the 1/10 second rotor 286 is rotatably arranged between the train wheel bridge (A) 106 and the main plate 102.

The time rotor (A) 246, the chronograph minute/second rotor 266 and the 1/10 rotor 286 are the same part. However, although the time rotor (A) 246 and the chronograph minute/second rotor 266 are integrated by disposing the pinion portions on an upper side (integrated such that the pinion portions are proximate to the train wheel bridge (A) 106), the 1/10 second rotor 286 is integrated by disposing the pinion portion on a lower side (integrated such that the pinion portion is proximate to the main plate 102).

A 1/10 second fifth wheel & pinion 270 is constituted to rotate based on rotation of the 1/10 second rotor 286. The 1/10 second fifth wheel & pinion 270 includes an upper shaft portion 270a, a lower shaft portion 270b, an upper pinion portion 270c, a wheel portion 270d and a lower pinion portion 270f. The wheel portion 270d of the 1/10 second fifth wheel & pinion 270 is constituted to be brought in mesh with the pinion portion 286c of the 1/10 second rotor 286. The upper shaft portion 270a of the 1/10 second fifth wheel & pinion 270 is rotatably integrated to a 1/10 second fifth wheel & pinion upper bearing portion 106s provided at the train wheel bridge (A) 106. The lower shaft portion 270b of the 1/10 second fifth wheel & pinion 270 is rotatably integrated to a 1/10 second fifth wheel &pinion lower bearing portion 102s provided at the main plate 102. Therefore, the 1/10 second fifth wheel & pinion 270 is rotatably arranged between the train wheel bridge (A) 106 and the main plate 102.

A 1/10 second-counter intermediate wheel (B) 272 is constituted to rotate based on rotation of the 1/10 second fifth wheel & pinion 270 via rotation of a 1/10 second-counter intermediate wheel (A) 271. Dimensions and shape of the 1/10 second-counter intermediate wheel (A) 271 are constituted to be the same as dimensions and shape of the 1/10 second-counter intermediate wheel (B) 272. The 1/10 second-counter intermediate wheel (A) 271 includes an upper shaft portion 271a, a lower shaft portion 271b and a wheel portion 271d. The wheel portion 271d of the 1/10 second-counter intermediate wheel (A) 271 is constituted to be brought in mesh with the lower pinion portion 270f of the 1/10 second fifth wheel & pinion 270. The upper shaft portion 271a of the 1/10 second-counter intermediate wheel (A) 271 is rotatably integrated to a 1/10 second-counter intermediate wheel (A) upper bearing portion 108t provided at the back train wheel bridge 108. The lower shaft portion 271b of the 1/10 second-counter intermediate wheel (A) 271 is rotatably integrated to a 1/10 second-counter intermediate wheel (A) lower bearing portion 102t provided at the main plate 102. Therefore, the 1/10 second-counter intermediate wheel (A) 271 is rotatably arranged between the back train wheel bridge 108 and the main plate 102.

The 1/10 second-counter intermediate wheel (B) 272 includes an upper shaft portion 272a, a lower shaft portion 272b and a wheel portion 272d. The wheel portion 272d of the 1/10 counter intermediate wheel (B) 272 is constituted to be brought in mesh with the wheel portion 271d of the 1/10 second-counter intermediate wheel (A) 271. The upper shaft portion 272a of the 1/10 second-counter intermediate wheel (B) 272 is rotatably integrated to a 1/10 second-counter intermediate wheel (B) upper bearing portion 108u (refer to a view of the back train wheel bridge, mentioned later) provided at the back train wheel bridge 108. The lower shaft portion 272b of the 1/10 second-counter intermediate wheel (B) 272 is rotatably integrated to a 1/10 second-counter intermediate wheel (B) lower bearing portion 102u (refer to a view of the main plate, mentioned later) provided at the main plate portion 102. Therefore, the 1/10 second-counter intermediate wheel (B) 272 is rotatably arranged between the back train wheel bridge 108 and the main plate 102.

A 1/10 second-counting wheel 274 is constituted to rotate based on rotation of the 1/10 second-counter intermediate wheel (B) 272. The 1/10 second-counting wheel 274 includes an upper shaft portion 274a, a lower shaft portion 274 band a wheel portion 274d. The wheel portion 274d of the 1/10 second counting wheel 254 is constituted to be brought in mesh with the wheel portion 272d of the 1/10 second-counter intermediate wheel (B) 272. The upper shaft portion 274a of the 1/10 second-counting wheel 274 is rotatably integrated to a 1/10 second-counting wheel upper bearing portion 108v (refer to a view of the back train wheel bridge, mentioned below) provided at the back train wheel bridge 108. The lower shaft portion 274b of the 1/10 second-counting wheel 274 is rotatably integrated to a 1/10 second-counting wheel lower bearing portion 102v (refer to a view of the main plate, mentioned later) provided at the main plate 102. Therefore, the 1/10 second-counting wheel 274 is rotatably arranged between the back train wheel bridge 108 and the main plate 102. A 1/10 second chronograph hand 275 is attached to the 1/10 second-counting wheel 274. The 1/10 second chronograph hand 275 constitutes a 1/10 second-counting indicating member. In the chronograph measuring mode, the 1/10 second chronograph hand 275 is operated to indicate “1/10 second” in elapse time.

In reference to FIG. 1, rotation center of the 1/10 second-counting wheel 274 is disposed at a position above the main plate reference horizontal axis line 304 and between the main plate center 300 and an outer shape portion 312 of the main plate 102 disposed in, “12 o'clock direction” of the movement 100. A distance between the rotation center of the 1/10 second-counting wheel 274 and the main plate center 300 is about ½ of a radius of a maximum outer shape portion of the main plate 102.

(1•5) Constitution of Main Plate

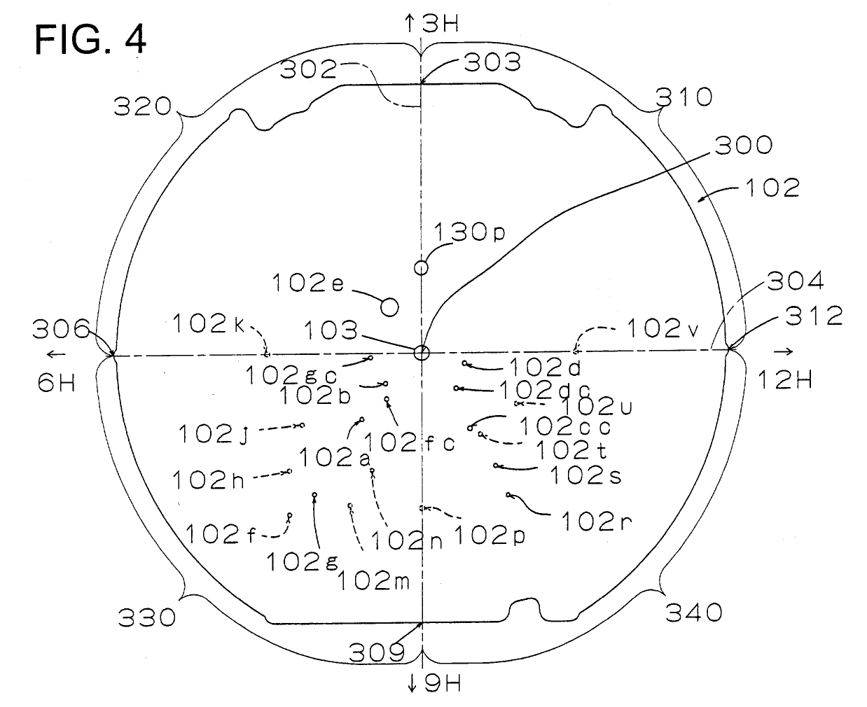

In reference to FIG. 1 and FIG. 4, at the main plate 102, the main plate center 300 is arranged with the center pipe 103. A rotation center shaft 130p of the setting wheel 130 is disposed at a position above the main plate reference vertical axis line 302 and between the main plate center 300 and an outer shape portion 303 of the main plate 102 disposed in “3 o'clock direction” of the movement 100. A minute wheel lower bearing portion 102e is arranged at the second region 320 in the main plate 102. Rotation center of the setting lever 134, rotation center of the yoke 136 and rotation center of the reset lever 140 are arranged at the second region 320 in the main plate 102.

The second-counting wheel lower bearing portion 102k is disposed at a position above the main plate reference horizontal axis line 304 and between the main plate center 300 and the outer shape portion 306 of the main plate 102 disposed in “6 o'clock direction” of the movement 100.

The time rotor (A) lower bearing portion 102a and the time fifth wheel & pinion (A) lower bearing portion 102b are arranged at the third region 330 in the main plate 102.

The chronograph minute/second rotor lower bearing portion 102f, the chronograph minute/second fifth wheel & pinion lower bearing portion 102g, the second-counter intermediate wheel (A) lower bearing portion 102h, the second-counter intermediate wheel (B) lower bearing portion 102j, the minute-counter intermediate wheel (A) lower bearing portion 102m and the minute-counter intermediate wheel (B) lower bearing portion 102n are arranged at the third region 330 in the main plate 102.

The minute-counting wheel lower bearing portion 102p is disposed at a position above the main plate reference vertical axis line 302 and between the main plate center 300 and the outer shape portion 309 of the main plate 102 disposed in “9 o'clock direction” of the movement 100.

The side third wheel & pinion lower bearing portion 102d is arranged at the fourth region 340 in the main plate 102.

The 1/10 second rotor lower bearing portion 102r, the 1/10 second fifth wheel & pinion lower bearing portion 102s, the 1/10 second-counter intermediate wheel (A) lower bearing portion 102t and the 1/10 second-counter intermediate wheel (B) lower bearing portion 102u are arranged at the fourth region 340 in the main plate 102.

The 1/10 second-counting wheel lower bearing portion 102v is disposed at a position above the main plate reference horizontal axis line 304 and between the main plate center 300 and the outer shape portion 312 of the main plate 102 disposed in “12 o'clock direction” of the movement 100.

(1•6) Constitutions of Train Wheel Bridge (A) and Train Wheel Bridge (B)

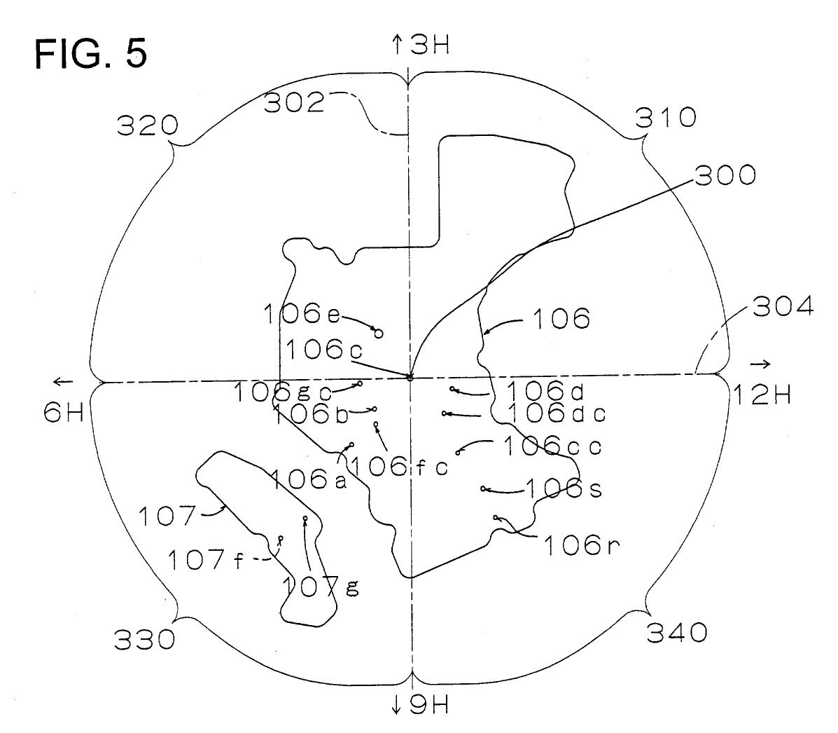

In reference to FIG. 1 and FIG. 5, in the train wheel bridge (A) 106, the side second wheel & pinion upper bearing portion. 106c is arranged at the main plate center 300. The minute wheel upper bearing portion 106e is arranged at the second region 320 in the train wheel bridge (A) 106.

The time rotor (A) upper bearing portion 106a and the time fifth wheel & pinion (A) upper bearing portion 106b are arranged at the third region 330 in the train wheel bridge (A) 106.

The chronograph minute/second rotor upper bearing portion 107f and the chronograph minute/second fifth wheel & pinion upper bearing portion 107g are arranged at the third region 330 in the train wheel bridge (B) 107.

The side third wheel & pinion upper bearing portion 106d is arranged at the fourth region 340 in the train wheel bridge (A) 106.

The 1/10 second rotor upper bearing portion 106r and the 1/10 second fifth wheel & pinion upper bearing portion 106s are arranged at the fourth region 340 in the train wheel bridge (A) 106.

(1•7) Constitution of Back Train Wheel Bridge

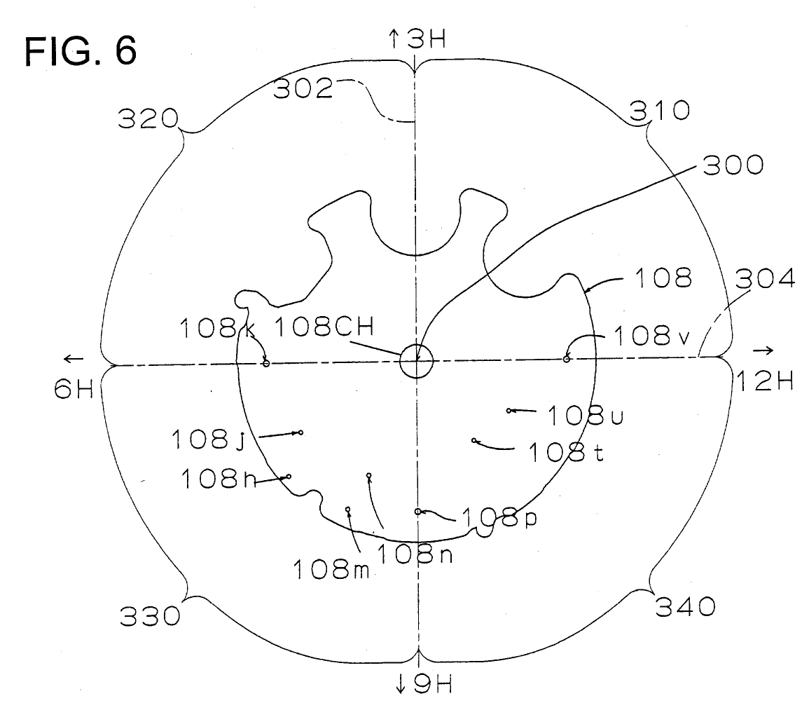

In reference to FIG. 1 and FIG. 6, in the back train wheel bridge 108, a center hole 108CH is provided at the main plate center 300.

The second-counting wheel upper bearing portion 108k is disposed at a position in the back train wheel 108, above the main plate reference horizontal axis line 304 and between the main plate center 300 and an outer shape portion of the back train wheel bridge 108 disposed in “6 o'clock direction” of the movement 100.

The second-counter intermediate wheel (A) upper bearing portion 108h, the second-counter intermediate wheel (B) upper bearing portion 108j, the minute-counter intermediate wheel (A) upper bearing portion 108m and the minute-counter intermediate wheel (B) upper bearing portion 108n are arranged at the third region 330 in the back train wheel bridge 108.

The minute-counting wheel upper bearing portion 108p is disposed at a position in the back train wheel bridge 108, above the main plate reference vertical axis line 302 and between the main plate center 300 and an outer shape portion of the back train wheel bridge 108 disposed in “9 o'clock direction” of the movement 100.

The 1/10 second-counter intermediate wheel (A) upper bearing portion 108t and the 1/10 second-counter intermediate wheel (B) upper bearing portion 108u are arranged at the fourth region 340 in the back train wheel bridge 108.

The 1/10 second-counting wheel upper bearing portion 108v is disposed at a position in the back train wheel bridge 108, above the main plate reference horizontal axis line 304 and between the main plate center 300 and an outer shape portion of the back train wheel bridge 108 disposed in “12 o'clock direction” of the movement 100.

(1•8) Arrangement of Parts in Movement

Next, a preferable arrangement of parts in the movement 100 will be explained.

In reference to FIG. 1, on the surface side of the movement 100, a rotation center 134c of the setting lever 134, a rotation center 136c of the yoke 136 and a rotation center 140c of the reset lever 140 are arranged at the second region 320. The yoke 136 is preferably fabricated by an elastically deformable material, for example, stainless steel. A spring portion of the yoke 136 is disposed in the second region 320 on the surface side of the movement 100. By constituting in this way, along spring can effectively arranged on the surface side of the movement.

The crystal unit 114 and IC (Integrated Circuit) 116 are arranged at the second region 320 on the surface side of the movement 100. By constituting in this way, the crystal unit 114 and IC (Integrated Circuit) 116 can effectively be arranged on the surface side of the movement. As a modified example, the crystal unit 114 may be arranged at the first region 310 on the surface side of the movement 100. As a modified example, IC (Integrated Circuit) 116 may be arranged at the first region 310 on the surface side of the movement 100.

A position of the reset lever 140 for setting the time fifth wheel & pinion (A) 220 is arranged at the third region 330 on the surface side of the movement 100. A position of the reset lever 140 for carrying out resetting operation is arranged at the second region 320 on the surface side of the movement 100. By constituting in this way, the reset lever 140 having a long spring portion can effectively be arranged on the surface side of the movement.

The center of the battery 120 may be arranged at the first region 310 on the surface side of the movement 100. However, the center of the battery 120 may be disposed at the fourth region 340 on the surface side of the movement 100. That is, although the center of the battery 120 may be disposed at the first region 310 or may be disposed at the fourth region 340, the battery 120 is arranged to overlap the main plate reference horizontal axis line 312 between the first region 310 and the fourth region 340. By constituting in this way, the battery 120 having a large size can effectively be arranged on the surface side of the movement 100.

A center (hereinafter, referred to as “coil block center”) 242c of a center axis line in a length direction of a coil wire winding portion of the time coil block for side 242 maybe arranged at the third region 330. Rotation center of the time rotor (A) 246 and rotation center of the time fifth wheel & pinion (A) 220 may be arranged at the third region 330. Rotation center of the third wheel & pinion for side 222 may be arranged at the fourth region 340. Rotation center of the minute wheel 226 may be arranged at the second region 320.

A coil block center 262c of the chronograph minute/second coil block 262 maybe arranged at the third region 330. Rotation center of the chronograph minute/second rotor 266, rotation center of the chronograph minute/second fifth wheel & pinion 250, rotation center of the second-counter intermediate wheel (A) 251, rotation center of the minute-counter intermediate wheel (A) 252, rotation center of the second-counter intermediate wheel (B) 253 and rotation center of the minute-counter intermediate wheel (B) 257 may be arranged at the third region 330. In the third region 330, the coil block center 262c of the chronograph minute/second coil block 262 is arranged on an outer side of the coil block center 242c of the time coil block for side 242. In the third region 330, rotation center of the chronograph minute/second rotor 266 is arranged on an outer side of rotation center of the time rotor (A) 246.

The rotation center of the second-counting wheel 254 is disposed at a position above the main plate reference horizontal axis line 304 and between the main plate center 300 and the outer shape portion 306 of the main plate 102 disposed in “6 o'clock direction” of the movement 100. The distance between rotation center of the second-counting wheel 254 and the main plate center 300 is preferably 30% through 70% of the radius of the maximum outer shape portion of the main plate 102, more preferably 45% through 55% of the radius of the maximum outer shape portion of the main plate 102 and particularly preferably about ½ of the radius of the maximum outer shape portion of the main plate 102.

Further, rotation center of the minute-counting wheel 258 is disposed at a position above the main plate reference vertical axis line 302 and between the main plate center 300 and the outer shape portion 309 of the main plate 102 disposed in “9 o'clock direction” of the movement 100. The distance between rotation center of the minute-counting wheel 258 and the main plate center 300 is preferably 30% through 70% of the radius of the maximum outer shape portion of the main plate 102, more preferably 45% through 55% of the radius of the maximum outer shape portion of the main plate 102 and particularly preferably about ½ of the radius of the maximum outer shape portion of the main plate 102.

A coil block center 282c of the 1/10 second coil block 282 may be arranged at the fourth region 340. Rotation center of the 1/10 second rotor 286, rotation center of the 1/10 second fifth wheel & pinion 270, rotation center of the 1/10 second-counter intermediate wheel (A) 271 and rotation center of the 1/10 second-counter intermediate wheel (B) 272 may be arranged at the fourth region 340. By constituting in this way, the plurality of coil blocks and the plurality of train wheels can effectively be arranged on the surface side of the movement. Here, a number of parts constituting the train wheels is not restricted to the above-described but one or more of transmission wheels can further be added.

Rotation center of the 1/10 second-counting wheel 274 is disposed at a position above the main plate reference horizontal axis line 304 and between the main plate center 300 and the outer shape portion 312 of the main plate 102 disposed in “12 o'clock direction” of the movement 100. The distance between rotation center of the 1/10 second-counting wheel 274 and the main plate center 300 is preferably 30% through 70% of the radius of the maximum outer shape portion of the main plate 102, more preferably, 45% through 55% of the radius of the maximum outer shape portion of the main plate 102 and particularly preferably about ½ of the radius of the maximum outer shape portion of the main plate 102.

It is preferable that the distance between the rotational center of the second-counting wheel 254 and the main plate center 300, the distance between rotation center of the minute-counting wheel 258 and the main plate center 300 and the distance between rotation center of the 1/10 second-counting wheel 274 and the main plate center 300 are all constituted to be an equal value.

(1•9) Operation of First Embodiment

Next, an explanation will be given of operation of the first embodiment of the analog electronic timepiece (analog chronograph timepiece) according to the invention.

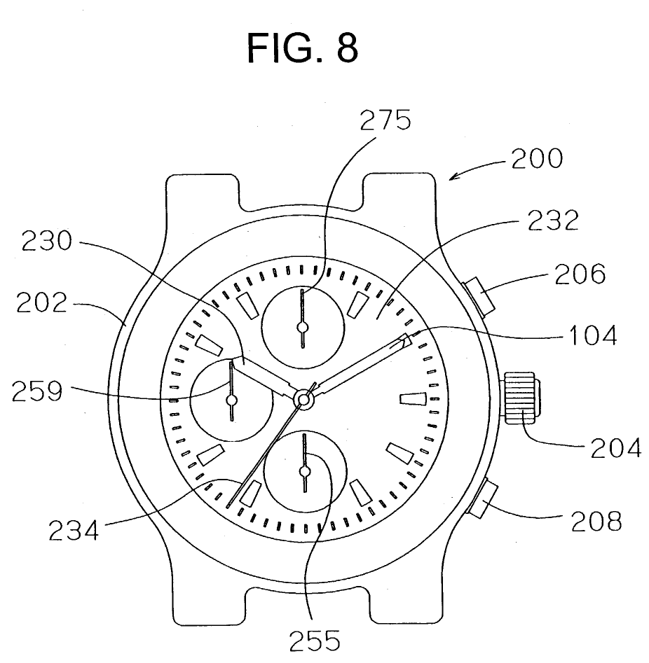

In reference to FIG. 8, a complete 200 of the side chronograph timepiece is provided with an outer case 202. The movement 100 and the dial 104 are contained in the outer case 202. A crown 204 is provided to the outer case 202 to rotate integrally with the hand setting stem 110. Time of the side chronograph timepiece is constituted to be able to set by pulling out the crown 204 to the first stage and rotating the crown 204. That is, when the crown 204 is pulled out to the first stage, the second hand 234 is stopped and the hour hand 230 and the minute hand 232 are constituted to be able to rotate by rotating the crown 204.

The outer case 202 is provided with start/stop button 206 for starting and stopping operation of chronograph of the side chronograph timepiece. When the start/stop button 206 is pushed, the switch spring is constituted to operate to transmit a signal with regard to starting operation or stopping operation of the chronograph to IC 116. The outer case 202 is provided with a reset button 208 for resetting the operation of the chronograph of the side chronograph timepiece. When the reset button 208 is pushed, the switch spring is constituted to operate to transmit a signal with regard to resetting operation of the chronograph to IC 116.

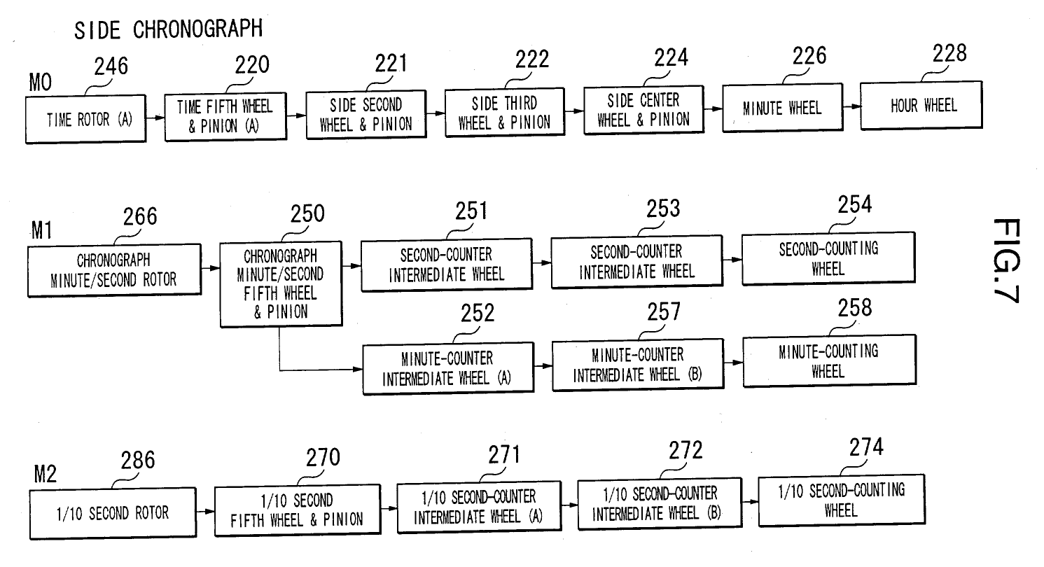

Here, operation of indicating current time will be explained. In reference to FIG. 1 through FIG. 3, FIG. 7 and FIG. 8, time of the side chronograph timepiece is set to current time by pulling out the crown 204 to the first stage and rotating the crown 204 and the crown 204 is pushed to the 0 stage. Under the state, the time rotor (A) 246 is rotated and the second wheel & pinion for side 221 is rotated based on rotation of the time rotor (A) 246 via rotation of the time fifth wheel & pinion (A) 220. The second wheel & pinion for side 221 is rotated by one rotation per minute and therefore, the second hand 234 attached to the second wheel & pinion for side 221 indicates “second” in current time.

Further, the center wheel & pinion for side 224 is rotated based on rotation of the second wheel & pinion for side 221 via rotation of the third wheel & pinion for side 222. The center wheel & pinion for side 224 is rotated by one rotation per hour and therefore, the minute hand 232 attached to the cannon pinion for side 224b of the center wheel & pinion for side 224 indicates “minute” of current time.

Further, the hour wheel 228 is rotated based on rotation of the center wheel & pinion for side 224 via rotation of the minute wheel 226. The hour wheel 228 rotates by one rotation per 12 hours and therefore, the hour hand 234 attached to the hour wheel 228 indicates “hour” of current time.

Next, operation of measuring the chronograph will be explained. In reference to FIG. 8, in a state in which the chronograph stops measuring and is reset, all of the minute-counting hand 259, the second-counting hand 255 and the 1/10 second-counting hand 275 are disposed at “zero positions (initial positions)”. That is, in the reset state, all of the minute-counting hand 259, the second-counting hand 255 and the 1/10 second-counting hand 275 are disposed at positions indicating “zero”.

In reference to FIG. 1 through FIG. 3, FIG. 7 and FIG. 8, when the start/stop button 206 is pushed to start measuring the chronograph, the chronograph measuring mode is started. In the chronograph measuring mode, the chronograph minute/second rotor 266 is rotated, and the chronograph minute/second fifth wheel & pinion 250 is rotated based on rotation of the chronograph minute/second rotor 266. Further, the second-counter intermediate wheel (A) and the minute-counter intermediate wheel (A) 252 are rotated based on rotation of the chronograph minute/second fifth wheel & pinion 250. The second-counting wheel 254 is rotated based on rotation of the second-counter intermediate wheel (A) 251 via rotation of the second-counter intermediate wheel (B) 253. In the chronograph measuring mode, the second-counting hand 255 attached to the second-counting wheel 254 indicates “second” in elapse time.

Further, the minute-counting wheel 258 is rotated based on rotation of the minute-counter intermediate wheel (A) 252 via rotation of the minute-counter intermediate wheel (B) 257. In the chronograph measuring mode, the minute-counting hand 259 attached to the minute-counting wheel 258 indicates “minute” of elapse time.

Further, in the chronograph measuring mode, the 1/10 second rotor 286 is rotated and the 1/10 fifth-wheel & pinion 270 is rotated based on rotation of the 1/10 second rotor 286. The 1/10 second-counter intermediate wheel (B) 272 is rotated based on rotation of the 1/10 second fifth wheel & pinion 270 via rotation of the 1/10 second-counter intermediate wheel (A) 271. The 1/10 second-counting wheel 274 is rotated based on rotation of the 1/10 second-counter intermediate wheel (B) 272. In the chronograph measuring mode, the 1/10 second-counting hand 275 attached to the 1/10 second-counting wheel 274 is operated to indicate “second” in elapse time by “1/10 second unit”.

In the chronograph measuring mode, when the start/stop button 206 is pushed further, measurement of the chronograph can be stopped. In a state of stopping to measure the chronograph, the minute-counting hand 259 is stopped in a state of indicating “minute” in elapse time, the second-counting hand 255 is stopped in a state of indicating “second” in elapse time and the 1/10 second-counting hand 275 is stopped in a state of indicating “second” in elapse time by “1/10 second unit”.

When the reset button 208 is pushed in a state of stopping measurement of the chronograph, all of the minute-counting hand 259, the second-counting hand 255 and the 1/10 second-counting hand 275 return to positions indicating “zero” (refer to FIG. 8).

(2) Second Embodiment

Next, a second embodiment of the invention will be explained. The second embodiment of the invention is “center chronograph timepiece” of an analog electronic timepiece, that is, an analog chronograph timepiece having a structure in which a chronograph second hand is arranged at a center of a movement and a small secondhand indicating time is arranged at a position other than the center of the movement. The following explanation will be carried out mainly with respect to a point of the second embodiment of the invention which differs from the first embodiment of the invention. Therefore, with regard to a portion other than content described below, the above-described explanation of the first embodiment of the invention will be applied thereto.

(2 1) Total Constitution of Movement

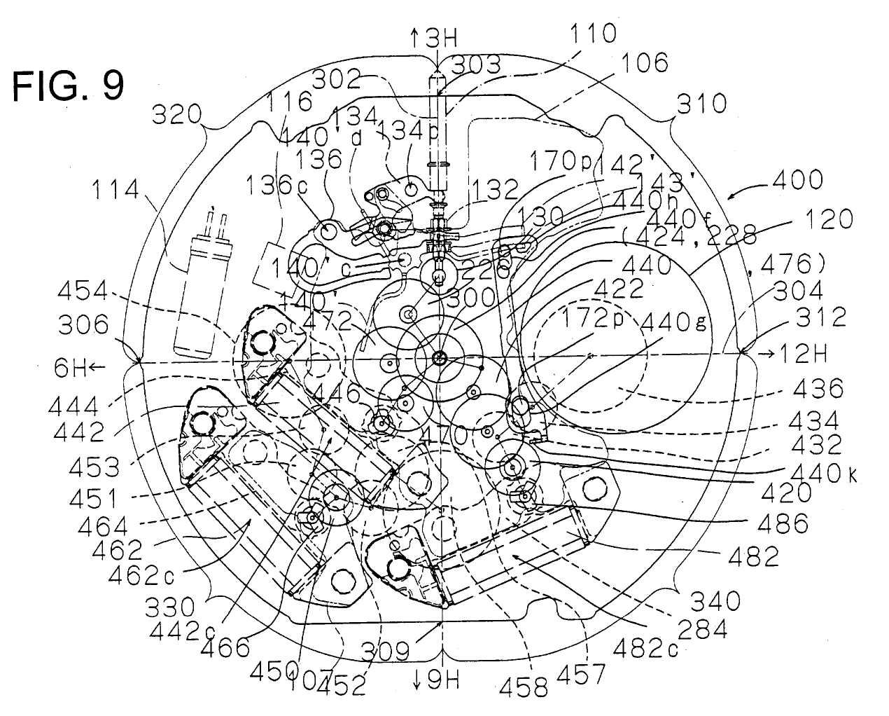

First, an explanation will be given of a total constitution of a movement of an analog chronograph timepiece according to the invention. In reference to FIG. 9 through FIG. 11, the analog chronograph timepiece of the invention is provided with a movement 400. The movement 400 is provided with the main plate 102 constituting the base plate of the movement 400, the train wheel bridge (A) 106, the train wheel bridge (B) 107 and the back train wheel bridge 108. The main plate 102, the train wheel bridge (A) 106, the train wheel bridge (B) 107 and the back train wheel bridge 108 are parts respectively the same as the main plate 102, the train wheel bridge (A) 106, the train wheel bridge (B) 107 and the back train wheel bridge 108 used in the above-described movement 100.

(2•2) Constitution of Time Indicating Train Wheel Portion

Next, a constitution of a time indicating train wheel portion will be explained. The time indicating train wheel portion includes a motor for driving a time indicating train wheel and the time indicating train wheel.

In reference to FIG. 9 through FIG. 11, “surface side” of the movement 400 is arranged with a circuit block, the battery 120, a time train wheel portion for center, a chronograph hour/minute train wheel portion, a ⅕ second train wheel portion and a switching apparatus. A center wheel & pinion for center 424 is rotatably integrated to the center hole of the center pipe 103. The center wheel & pinion for center 424 includes a center wheel for center 424a and a cannon pinion for center 424b. The center wheel & pinion for center 424 used in the movement 400 is a part the same as that of the center wheel & pinion for side 224 used in the above-described movement 100.

The time train wheel portion for center includes a motor for driving the time train wheel for center, that is, a time motor for center and a time train wheel for center. The time train wheel for center is constituted to rotate by rotation of the time motor for center to thereby indicate “hour” in current time by the hour hand 230, indicate “minute” in current time by the minute hand 232 and indicate “second” in current time by a second hand (that is, small second hand) 434.

The time motor for center includes a time coil block for center 482, a time stator for center 484 and a time rotor for center, that is, a time rotor (B) 486. The time coil block for center 482, the time stator for center 484, and the time rotor (B) 486 are parts respectively the same as the 1/10 second coil block 282, the 1/10 second stator 284 and the 1/10 second rotor 286 used in the above-described movement 100.

When a time motor drive signal outputted by IC (Integrated Circuit) 116 is inputted to the time coil block 242, the time stator for center 484 is magnetized to rotate the time rotor (B) 486. According to IC (Integrated Circuit) 116, IC for a side chronograph timepiece and IC for a center chronograph timepiece can be fabricated separately or single IC can be dividedly used for two functions by switching a conductive state of two of function setting terminals by constituting IC for a side chronograph timepiece and IC for a center chronograph timepiece by the same IC. For example, the embodiment of the invention can be constituted such that IC (Integrated Circuit) 116 is provided with a terminal TS for a side chronograph timepiece and a terminal TC for a center chronograph timepiece and when the terminal TS is conducted to plus of the battery 120, IC 116 is operated as IC for the side chronograph timepiece and when the terminal TC is conducted to plus of the battery 120, IC 116 is operated as IC for the center chronograph timepiece. That is, according to the embodiment of the invention, IC for the side chronograph timepiece is a part the same as IC for the center chronograph timepiece.

The time rotor (B) 486 is constituted to rotate by, for example, 180 degrees per second. The time rotor (B) 486 includes an upper shape portion 486a, a lower shaft portion 486b, a pinion portion 486c and a rotor magnet 486d. The upper shaft portion 486a of the time rotor (B) 486 is rotatably integrated to a time rotor (B) upper bearing portion 106a provided at the train wheel bridge (A) 106. The time rotor (B) upper bearing portion 106a is the same as the time rotor (A) upper bearing portion 106a used in the above-described movement 100. The lower shaft portion 486b of the time rotor (A) 486 is rotatably integrated to a time rotor (B) lower bearing portion 102a provided at the main plate 102. The time rotor (B) lower bearing portion 102a is the same as the time rotor (A) lower bearing portion 102a used in the above-described movement 100. Therefore, the time rotor (B) 486 is rotatably arranged between the train wheel bridge (A) 106 and the main plate 102.

A time fifth wheel & pinion for center, that is, a time fifth wheel & pinion (B) 420 is constituted to rotate based on rotation of the time rotor (B) 486. The time fifth wheel & pinion (B) 420 used in the movement 400 is a part the same as the 1/10 second fifth wheel & pinion 270 used in the above-described movement 100. The time fifth wheel & pinion (B) 420 includes an upper shaft portion 420a, a lower shaft portion 420b, an upper pinion portion 420c, a wheel portion 420d and a lower pinion portion 420f. The wheel portion 420d of the time fifth wheel & pinion (B) 420 is constituted to be brought in mesh with the pinion portion 486c of the time rotor (B) 486. The upper shaft portion 420a of the time fifth wheel & pinion (B) 420 is rotatably integrated to a time fifth wheel & pinion (B) upper bearing portion 106s provided at the train wheel bridge (A) 106. The time fifth wheel & pinion (B) upper bearing portion 106s is the same as the 1/10 second fifth wheel & pinion upper bearing portion 106s used in the above-described movement 100. The lower shaft portion 420b of the time fifth wheel & pinion (B) 420 is rotatably integrated to a time fifth wheel & pinion (B) lower bearing portion 102s provided at the main plate 102. The time fifth wheel &pinion (B) lower bearing portion 102s used in the movement 400 is the same as the 1/10 second fifth wheel & pinion lower bearing portion 102s used in the above-described movement 100. Therefore, the time fifth wheel & pinion (B) 420 is rotatably arranged between the train wheel bridge (A) 106 and the main plate 102.

A fourth wheel & pinion for center 421 and an intermediate small second wheel 432 are constituted to rotate based on rotation of the time fifth wheel & pinion (B) 420. The fourth wheel & pinion for center 421 includes an upper shaft portion 421a, a lower shaft portion 421b, a pinion portion 421c and a wheel portion 421d. The wheel portion 421d of the fourth wheel & pinion for center 421 is constituted to be brought in mesh with the upper pinion portion 420c of the time fifth wheel & pinion (B) 420. The upper shaft portion 421a of the fourth wheel & pinion for center 421 is rotatably integrated to a center fourth wheel & pinion upper bearing portion 106cc provided at the train wheel bridge (A) 106. Therefore, the fourth wheel & pinion for center 421 is arranged rotatably between the train wheel bridge (A) 106 and the main plate 102.

The center wheel & pinion for center 424 is constituted to rotate based on rotation of the fourth wheel & pinion for center 421 via rotation of a third wheel & pinion for center 422. The third wheel & pinion for center 422 includes an upper shaft portion 422a, a lower shaft portion 422b, a pinion portion 422c and a wheel portion 422d. The wheel portion 422d of the third wheel & pinion for center 422 is constituted to be brought in mesh with the pinion portion 421c of the fourth wheel & pinion for center 421. The upper shaft portion 422a of the third wheel & pinion for center 422 is rotatably integrated to a center third wheel & pinion upper bearing portion 106dc provided at the train wheel bridge (A) 106. The lower shaft portion 422b of the third wheel & pinion for center 422 is rotatably integrated to a center third wheel & pinion lower bearing portion 102dc provided at the main plate 102. Therefore, the third wheel & pinion for center 422 is rotatably arranged between the train wheel bridge (A) 106 and the main plate 102. The center wheel & pinion for center 424 is constituted to rotate by one rotation per hour. The minute hand 232 is attached to a cannon pinion for center 424b of the center wheel & pinion for center 424.

The hour wheel 228 is constituted to rotate based on rotation of the center wheel & pinion for center 424 via rotation of the minute wheel 226. The minute wheel 226 and the hour wheel 228 used in the movement 400 are parts respectively the same as the minute wheel 226 and the hour wheel 228 used in the above-described movement 100. Rotation center of the hour wheel 228 is disposed at a position the same as rotation center of the second wheel & pinion for center 224. However, rotation center of the fourth wheel & pinion for center 421 is disposed at a position different from rotation center of the center wheel & pinion for center 224. The hour wheel 228 is constituted to rotate by one rotation per 12 hours.

An intermediate small second wheel (A) 432 is constituted to rotate based on rotation of the time fifth wheel & pinion (B) 420. The intermediate small second wheel (A) 432 includes an upper shaft portion 432a, a lower shaft portion 432b and a wheel portion 432d. The wheel portion 432d of the intermediate small second wheel (A) 432 is constituted to be brought in mesh with the lower pinion portion 420f of the time fifth wheel & pinion (B) 420. The upper shaft portion 432a of the intermediate small second wheel (A) 432 is rotatably integrated to an intermediate small second wheel (A) upper bearing portion 108t provided at the back train wheel bridge 108. The intermediate small second wheel (A) upper bearing portion 108t used in the movement 400 is the same as the 1/10 second-counter intermediate wheel (A) upper bearing portion 108t used in the above-described movement 100. The lower shaft portion 432b of the intermediate small second wheel (A) 432 is rotatably integrated to an intermediate small second wheel (A) lower bearing portion 102t provided at the main plate 102. The intermediate small second wheel (A) lower bearing portion 102t used in the movement 400 is the same as the 1/10 second-counter intermediate wheel (A) lower bearing portion 102t used in the above-described movement 100. Therefore, the intermediate small second wheel (A) 432 is arranged rotatably between the back train wheel bridge 108 and the main plate 102.

A small second wheel 436 is constituted to rotate based on rotation of the intermediate small second wheel (A) 432 via rotation of an intermediate small second wheel (B) 434. Dimensions and shape of the intermediate small second wheel (A) 432 are constituted to be the same as dimensions and shape of the intermediate small second wheel (B) 434. Further, dimensions and shape of the intermediate small second wheel (A) 432, dimensions and shape of the intermediate small second wheel (B) 434, dimensions and shape of the second-counter intermediate wheel (A) 251 and dimensions and shape of the second-counter intermediate wheel (B) 253 are the same.

The intermediate small second wheel (B) 434 includes an upper shaft portion 434a, a lower shaft portion 434b and a wheel portion 434d. The wheel portion 434d of the intermediate small second wheel (B) 434 is constituted to be brought in mesh with the wheel portion 432d of the intermediate small second wheel (A) 432. The upper shaft portion 434a of the intermediate small second wheel (B) 434 is rotatably integrated to an intermediate small second wheel (B) upper bearing portion 108u provided at the back train wheel bridge 108. The intermediate small second wheel (B) upper bearing portion 108u used in the movement 400 is the same as the 1/10 second-counter intermediate wheel (B) upper bearing portion 108u used in the above-described movement 100. The lower shaft portion 434b of the intermediate small second wheel (B) 434 is rotatably integrated to an intermediate small second wheel (B) lower bearing portion 102u provided at the main plate 102. The intermediate small second wheel (B) lower bearing portion 102u used in the movement 400 is the same as the 1/10 second-counter intermediate wheel (B) lower bearing portion 102u used in the above-described movement 100. Therefore, the intermediate small second wheel (B) 434 is rotatably arranged between the back train wheel bridge 108 and the main plate 102.

The small second wheel 436 includes an upper shaft portion 436a, a lower shaft portion 436b and a wheel portion 436d. The wheel portion 436d of the small second wheel 436 is constituted to be brought in mesh with the wheel portion 434d of the intermediate small second wheel (B) 434. The upper shaft portion 436a of the small second wheel 436 is rotatably integrated to a small second wheel upper bearing portion 108v provided at the back train wheel bridge 108. The small second wheel upper bearing portion 108v used in the movement 400 is the same as the 1/10 second-counting wheel upper bearing portion 102v used in the above-described movement 100. The lower shaft portion 436b of the small second wheel 436 is rotatably integrated to a small second wheel lower bearing portion 102v provided at the main plate 102. The small second wheel lower bearing portion 102v used in the movement 400 is the same as the 1/10 second-counting wheel lower bearing portion 102v used in the above-described movement 100. Therefore, the small second wheel 436 is rotatably arranged between the back train wheel bridge 108 and the main plate 102. A small second hand 438 is attached to the small second wheel 436. The small second hand 438 constitutes a second indicating member.

In reference to FIG. 9, rotation center of the small second wheel 436 is disposed at a position above the main plate reference horizontal axis line 304 and between the main plate center 300 and the outer shape portion 312 of the main plate 102 disposed in “12 o'clock direction” of the movement 100. The distance between rotation center of the small second wheel 436 and the main plate center 300 is about ½ of a radius of a maximum outer shape portion of the main plate 102.

In reference to FIG. 0.9 and FIG. 11, a reset lever 140′ includes the reset conduction spring 140d for carrying out resetting operation, a train wheel resetting lever holding portion 142 for holding a train wheel setting lever 440 and the operation spring 143 for operating the train wheel setting lever 440. Dimensions and shape of the reset lever 140′ can be made the same as dimensions and shape of the reset lever 140 used in the above-described movement 100 except that there is not the train wheel setting portion 140f.

In a state of pulling out the hand setting stem 110 to the first stage, the analog chronograph timepiece is constituted to be able to reset by conducting the reset conduction spring 140d of the reset lever 140′ to a reset pattern of the circuit block. In the state of pulling out the hand setting stem 110 to the first stage, the train wheel setting lever 440 is constituted to be able to set rotation of the intermediate small second wheel (B) 434 based on operation of the reset lever 140′. The train wheel setting lever 440 includes guide window portions 440f and 440g having a shape of a long hole, an operation window portion 440h inserted with the operation spring 143 of the reset lever 140′ and a train wheel setting portion 440k for setting rotation of the intermediate small second wheel (B) 434. The main plate 102 is provided with two guide pins 170p and 172p respectively inserted into the guide window portions 440f and 440g of the train wheel setting lever 440. The guide window portion 440f of the train wheel setting lever 440 is guided by the guide pin 170p of the main plate 102. The guide window portion 440g of the train wheel setting lever 440 is guided by the guide pin 172p of the main plate 102. Therefore, the train wheel setting lever 440 is integrated to the main plate 102 to be able to move linearly relative to the main plate 102.

The train wheel setting lever 440 is arranged not to overlap the battery 120. Further, the train wheel setting lever 440 is arranged not to overlap a part attached with a hand. The operation window portion 440h of the train wheel setting lever 440 is inserted with the operation spring 143 of the reset lever 140′. When the hand setting stem 110 is pulled out to the first stage, the reset lever 140′ is rotated. When the reset lever 140′ is rotated, by rotation of the operation spring 143, the train wheel setting lever 440 can linearly be moved by being guided by the guide pins 170p and 172p. When the train wheel setting lever 440 is linearly moved, the train wheel setting portion 440k of the train wheel setting lever 440 can set rotation of the intermediate small second wheel (B) 434.

(2•3) Constitution of Chronograph Hour/Minute Indicating Train Wheel Portion

Next, an explanation will be given of a constitution of a chronograph hour/minute indicating train wheel portion operated in the chronograph measuring mode in the analog electronic timepiece (analog chronograph timepiece) according to the invention. The chronograph hour/minute indicating train wheel portion includes a motor for driving a chronograph hour/minute indicating train wheel and the chronograph hour/minute indicating train wheel.

In reference to FIG. 9, the chronograph hour/minute indicating train wheel portion includes the motor for driving the chronograph hour/minute indicating train wheel, that is, a chronograph hour/minute motor and the chronograph hour/minute indicating train wheel. The chronograph hour/minute indicating train wheel is constituted to rotate by rotation of the chronograph hour/minute motor to indicate “chronograph minute” in elapse time measured in the chronograph measuring mode by a chronograph minute hand and to indicate “chronograph hour” in elapse time measured in the chronograph measuring mode by a chronograph hour hand. In the chronograph measuring mode, IC (Integrated Circuit) 116 is constituted to measure elapse time and operate the chronograph hour/minute motor.

The chronograph hour/minute motor includes a chronograph hour/minute coil block 462, a chronograph hour/minute stator 464 and a chronograph hour/minute rotor 466. The chronograph hour/minute coil block 462, the chronograph hour/minute stator 464 and the chronograph hour/minute rotor 466 used in the movement 400 are parts respectively the same as the chronograph minute/second coil block 262, the chronograph minute/second stator 264 and the chronograph minute/second rotor 266 used in the above-described movement 100.

When a chronograph hour/minute motor drive signal outputted by IC (Integrated Circuit) 116 is inputted to the chronograph hour/minute coil block 462, the chronograph hour/minute stator 464 is magnetized to rotate the chronograph hour/minute rotor 466. The chronograph hour/minute rotor 466 is constituted to rotate by, for example, 180 degrees per minute. The chronograph hour/minute rotor 466 can also be constituted to rotate by 180 degrees per 10 seconds, 20 seconds or 30 seconds. The chronograph hour/minute rotor 466 includes an upper shaft portion, a lower shaft portion, a pinion portion and a rotor magnet. The upper shaft portion of the chronograph hour/minute rotor 466 is rotatably integrated to a chronograph hour/minute rotor upper bearing portion 107f provided at the train wheel bridge (B) 107. The chronograph hour/minute rotor upper bearing portion 107f used in the movement 400 is the same as the chronograph minute/second rotor upper bearing portion 107f used in the above-described movement 100. The lower shaft portion of the chronograph hour/minute rotor 466 is rotatably integrated to a chronograph hour/minute rotor lower bearing portion 102f provided at the main plate 102. The chronograph hour/minute rotor lower bearing portion 102f used in the movement 400 is the same as the chronograph minute/second rotor lower bearing portion 102f used in the above-described movement 100. Therefore, the chronograph hour/minute rotor 466 is rotatably arranged between the train wheel bridge (B) 107 and the main plate 102.

A chronograph hour/minute fifth wheel & pinion 450 is constituted to rotate based on rotation of the chronograph hour/minute rotor 466. A minute-counter intermediate wheel (C) 451 and a second-counter intermediate wheel (A) 452 are constituted to rotate based on rotation of the chronograph hour/minute fifth wheel & pinion 450. The chronograph hour/minute fifth wheel & pinion 450 includes an upper shaft portion, a lower shaft portion, a pinion portion and a wheel portion. The wheel portion of the chronograph hour/minute fifth wheel & pinion 450 is constituted to be brought in mesh with the pinion portion of the chronograph hour/minute rotor 466. The upper shaft portion of the chronograph hour/minute fifth wheel & pinion 450 is rotatably integrated to a chronograph hour/minute fifth wheel & pinion upper bearing portion 107g provided at the train wheel bridge (B) 107. The chronograph hour/minute fifth wheel & pinion upper bearing portion 107g used in the movement 400 is the same as the chronograph minute/second fifth wheel & pinion upper bearing portion 107g used in the above-described movement 100. The lower shaft portion of the chronograph hour/minute fifth wheel & pinion 450 is rotatably integrated to a chronograph hour/minute fifth wheel & pinion lower bearing portion 102g provided at the main plate 102. The chronograph hour/minute fifth wheel & pinion lower bearing portion 102g used in the movement 400 is the same as the chronograph minute/second fifth wheel & pinion lower bearing portion 102g used in the above-described movement 100. Therefore, the chronograph hour/minute fifth wheel & pinion 450 is rotatably arranged between the train wheel bridge (B) 107 and the main plate 102.

A minute-counting wheel 454 is constituted to rotate based on rotation of the minute-counter intermediate wheel (C) 451 via rotation of a minute-counter intermediate wheel (D) 453. Dimensions and shape of the minute-counter intermediate wheel (C) 451 are constituted to be same as dimensions and shape of the minute-counter intermediate wheel (D) 453. Further, all of dimensions and shape of the minute-counter intermediate wheel (C) 451, dimensions and shape of the minute-counter intermediate wheel (D) 453, dimensions and shape of the second-counter intermediate wheel (A) 251 and dimensions and shape of the second-counter intermediate wheel (B) 253 are the same.

The minute-counter intermediate wheel (C) 451 includes an upper shaft portion, a lower shaft portion and a wheel portion. The wheel portion of the minute-counter intermediate wheel (C) 451 is constituted to be brought in mesh with the pinion portion of the chronograph hour/minute fifth wheel & pinion 450. The upper shaft portion of the minute-counter intermediate wheel (C) 451 is rotatably integrated to a minute-counter intermediate wheel (C) upper bearing portion 108h provided at the back train wheel bridge 108. The minute-counter intermediate wheel, (C) upper bearing portion 108h used in the movement 400 is the same as the second-counter intermediate wheel (A) upper bearing portion 108h used in the above-described movement 100. The lower shaft portion of the minute-counter intermediate wheel (C) 451 is rotatably integrated to a minute-counter intermediate wheel (C) lower bearing portion 102h provided at the main plate 102. The minute-counter intermediate wheel (C) lower bearing portion 102h used in the movement 400 is the same as the second-counter intermediate wheel (A) lower bearing portion 102h used in the above-described movement 100. Therefore, the minute-counter intermediate wheel (C) 451 is rotatably arranged between the back train wheel bridge 108 and the main plate 102.

The minute-counter intermediate wheel (D) 453 includes an upper shaft portion, a lower shaft portion and a wheel portion. The wheel portion of the minute-counter intermediate wheel (D) 453 is constituted to be brought in mesh with the wheel portion of the minute-counter intermediate wheel (C) 451. The upper shaft portion of the minute-counter intermediate wheel (D) 453 is rotatably integrated to a minute-counter intermediate wheel (D) upper bearing portion 108j provided at the back train wheel bridge 108. The minute-counter intermediate wheel (D) upper bearing portion 108j used in the movement 400 is the same as the second-counter intermediate wheel (B) upper bearing portion 108j used in the above-described movement 100. The lower shaft portion of the minute-counter intermediate wheel (D) 453 is rotatably integrated to a minute-counter intermediate wheel (D) lower bearing portion 102j provided at the main plate 102. The minute-counter intermediate wheel (D) lower bearing portion 102j used in the movement 400 is the same as the second-counter intermediate wheel (B) lower bearing portion 102j used in the above-described movement 100. Therefore, the minute-counter intermediate wheel (D) 453 is rotatably arranged between the back train wheel bridge 108 and the main plate 102.

The minute-counting wheel 454 is constituted to rotate based on rotation of the minute-counter intermediate wheel (D) 453. The minute-counting wheel 454 includes an upper shaft portion, a lower shaft portion and a wheel portion. The wheel portion of the minute-counting wheel 454 is constituted to be brought in mesh with the wheel portion of the minute-counter intermediate wheel (D) 453. The upper shaft portion of the minute-counting wheel 454 is rotatably integrated to a minute-counting wheel upper bearing portion 108k provided at the back train wheel bridge 108. The minute-counting wheel upper bearing portion 108k used in the movement 400 is the same as the second-counting wheel upper bearing portion 108k used in the above-described movement 100. The lower shaft portion of the minute-counting wheel 454 is rotatably integrated to a minute-counting wheel lower bearing portion 102k provided at the main plate 102. The minute-counting wheel lower bearing portion 102k used in the movement 400 is the same as the second-counting wheel lower bearing portion 102k used in the above-described movement 100. Therefore, the minute-counting wheel 454 is rotatably arranged between the back train wheel bridge 108 and the main plate 102. A minute-counting hand 455 (refer to a view of a complete, mentioned later) is attached to the minute-counting wheel 454. The minute-counting hand 455 constitutes a minute chronograph indicating member. In the chronograph measuring mode, the minute-counting hand 455 is operated to indicate “minute” in elapse time.

In reference to FIG. 9, rotation center of the minute-counting wheel 454 is disposed at a position above the main plate reference horizontal axis line 304 and between the main plate center 300 and the outer shape portion 306 of the main plate 102 disposed “16 o'clock direction” of the movement 100. A distance between rotation center of the minute-counting wheel 454 and the main plate center 300 is about ½ of a maximum outer shape portion of the main plate 102.

An hour-counting wheel 458 is constituted to rotate based on rotation of an hour-counter intermediate wheel (A) 452 via rotation of an hour-counter intermediate wheel (B) 457. The hour/counter intermediate wheel (A) 452 includes an upper shaft portion, a lower shaft portion, a pinion portion and a wheel portion. The wheel portion of the hour-counter intermediate wheel (A) 452 is constituted to be brought in mesh with the pinion portion of the chronograph hour/minute fifth wheel & pinion 450. The upper shaft portion of the hour-counter intermediate wheel (A) 452 is rotatably integrated to an hour-counter intermediate wheel (A) upper bearing portion 108m provided at the back train wheel bridge 108. The hour-counting intermediate wheel (A) upper bearing portion 108m used in the movement 400 is the same as the minute-counter intermediate wheel (A) upper bearing portion 108m used in the above-described movement 100. The lower shaft portion of the hour-counter intermediate wheel (A) 452 is rotatably integrated to an hour-counter intermediate wheel (A) lower bearing portion 102m provided at the main plate 102. The hour-counter intermediate wheel (A) lower bearing portion 102m used in the movement 400 is the same as the minute-counter intermediate wheel (A) lower bearing portion 102m used in the above-described movement 100. Therefore, the hour-counter intermediate wheel (A) 452 is rotatably arranged between the back train wheel bridge 108 and the main plate 102.

The hour-counter intermediate wheel (B) 457 includes an upper shaft portion, a lower shaft portion, a pinion portion and a wheel portion. The hour-counter intermediate wheel (B) 457 is constituted to be brought in mesh with the pinion portion of the hour-counter intermediate wheel (A) 452. The upper shaft portion of the hour-counter intermediate wheel (B) 457 is rotatably integrated to an hour-counter intermediate wheel (B) upper bearing portion 108n provided at the back train wheel bridge 108. The hour-counter intermediate wheel (B) upper bearing portion 108n used in the movement 400 is the same as the minute-counter intermediate wheel (A) upper bearing portion 108n used in the above-described movement 100. The lower shaft portion of the hour-counter intermediate wheel (B) 457 is rotatably integrated to an hour-counter intermediate wheel (B) lower bearing portion 102n provided at the main plate 102. The hour-counter intermediate wheel (A) lower bearing portion 102n used in the movement 400 is the same as the minute-counter intermediate wheel (A) lower bearing portion 108n used in the above-described movement 100. Therefore, the hour-counter intermediate wheel (B) 457 is rotatably arranged between the back train wheel bridge 108 and the main plate 102.

The hour-counting wheel 458 includes an upper shaft portion, a lower shaft portion and a wheel portion. The wheel portion of the hour-counting wheel 458 is constituted to be brought in mesh with the wheel portion of the minute-counter intermediate wheel (B) 257. The upper shaft portion of the hour-counting wheel 458 is rotatably integrated to an hour-counting wheel upper bearing portion 108p provided at the back train wheel bridge 108. The hour-counting wheel upper bearing portion 108p used in the movement 400 is the same as the minute-counting wheel upper bearing portion 108p used in the above-described movement 100. The lower shaft portion of the hour-counting wheel 458 is rotatably integrated to an hour-counting wheel lower bearing portion 102p provided at the main plate 102. The hour-counting wheel lower bearing portion 102p used in the movement 400 is the same as the minute-counting wheel lower bearing portion 102p used in the above-described movement 100. Therefore, the hour-counting wheel 458 is rotatably arranged between the back train wheel bridge 108 and the main plate 102. An hour chronograph hand 459 (refer to a view of a complete, mentioned later) is attached to the hour-counting wheel 458. The hour-counting hand 459 constitutes an hour chronograph indicating member. In the chronograph measuring mode, the hour chronograph hand 459 is operated to indicate “hour” in elapse time.

In reference to FIG. 1, rotation center of the hour-counting wheel 458 is disposed at a position above the main plate reference vertical axis line 302 and between the main plate center 300 and the outer shape portion 309 of the main plate 102 disposed in “9 o'clock direction” of the movement 100. A distance between rotation center of the hour-counting wheel 458 and the main plate center 300 is about ½ of a radius of a maximum outer shape portion of the main plate 102.

(2•4) Constitution of ⅕ Second Indicating Train Wheel Portion

Next, an explanation will be given of a constitution of a ⅕ second indicating train wheel portion operated in the chronograph measuring mode in the analog electronic timepiece (analog chronograph timepiece) according to the invention. A 1/10 second indicating train wheel portion includes a motor for driving a 1/10 second indicating train wheel and the ⅕ second indicating train wheel.

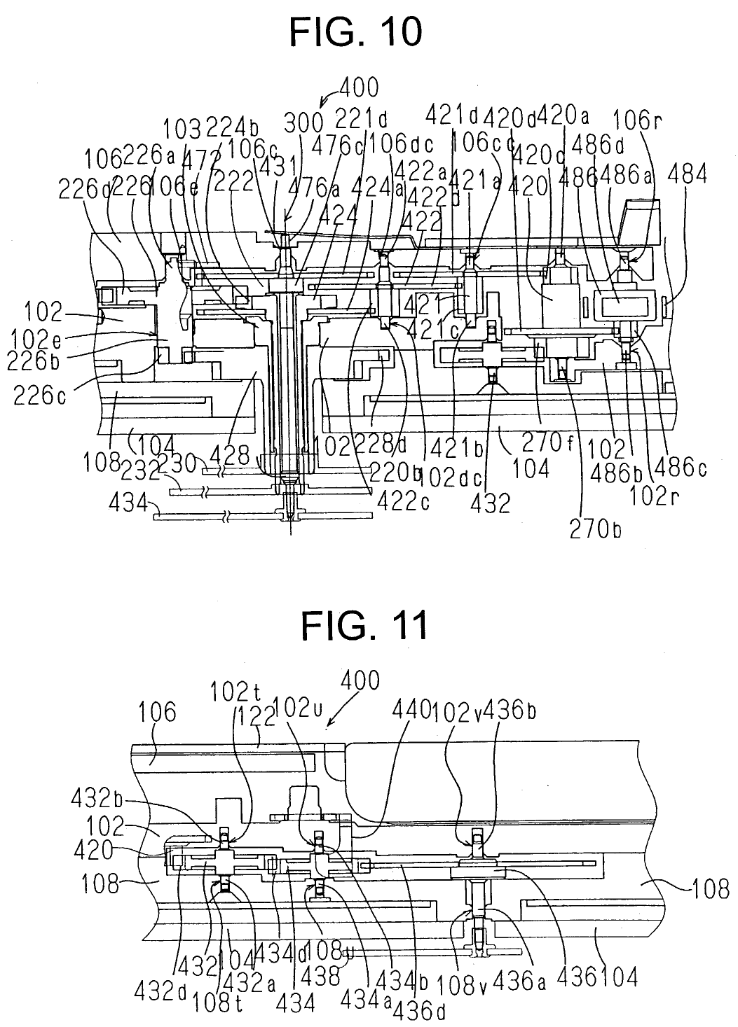

In reference to FIG. 9 and FIG. 10, a ⅕ second motor includes a ⅕ second coil block 442, a ⅕ second stator 444 and a ⅕ second rotor 446.

The ⅕ second coil block 442 and the ⅕ second rotor 446 used in the movement 400 are parts respectively the same as the time coil block for side 242 and the time rotor (A) 246 used in the above-described movement 100. Dimensions and shape of the ⅕ second stator 444 used in the movement 400 are the same as dimensions and shape of the time stator for side 244 used in the above-described movement 100 except a shape of a notch portion for controlling to rotate the time rotor (A) 246.

When a ⅕ second motor drive signal outputted by IC (Integrated Circuit) 116 is inputted to the ⅕ second coil block 442, the ⅕ second stator 444 is magnetized to rotate the ⅕ second rotor 446. The ⅕ second rotor 446 is constituted to rotate by, for example, 180 degrees per ⅕ second. The ⅕ second rotor 446 includes an upper shaft portion, a lower shaft portion, a pinion portion and a rotor magnet. The upper shaft portion of the ⅕ second rotor 446 is rotatably integrated to a ⅕ second rotor upper bearing portion 106a provided at the train wheel bridge (A) 106. The ⅕ second rotor upper bearing portion 106a used in the movement 400 is the same as the time rotor (A) upper bearing portion 106a used in the above-described movement 100. The lower shaft portion of the ⅕ second rotor 446 is rotatably integrated to a ⅕ second rotor bearing portion 102a provided at the main plate 102. The ⅕ second rotor lower bearing portion 102a used in the movement 400 is the same as the time rotor (A) lower bearing portion 102a used in the above-described movement 100. Therefore, the ⅕ second rotor 446 is rotatably arranged between the train wheel bridge (A) 106 and the main plate 102.

A ⅕ CG intermediate wheel (A) 470 is constituted to rotate based on rotation of the ⅕ second rotor 446. The ⅕ CG intermediate wheel (A) 470 includes an upper shaft portion, a lower shaft portion, a pinion portion and a wheel portion. The wheel portion of the ⅕ CG intermediate wheel (A) 470 is constituted to be brought in mesh with the pinion portion of the ⅕ second rotor 446. The upper shaft portion of the ⅕ CG intermediate wheel (A) 470 is rotatably integrated to a ⅕ CG intermediate wheel (A) upper bearing portion 106fc (refer to a view of a train wheel bridge, mentioned later) provided at the train wheel bridge (A) 106. The lower shaft portion of the ⅕ CG intermediate wheel (A) 470 is rotatably integrated to a ⅕ CG intermediate wheel (A) lower bearing portion 102fc (refer to a view of a main plate, mentioned later) provided at the main plate 102. Therefore, the ⅕ CG intermediate wheel (A) 470 is rotatably arranged between the train wheel bridge (A) 106 and the main plate 102.

A ⅕ CG wheel 476 is constituted to rotate based on rotation of the ⅕ CG intermediate wheel (A) 470 via rotation of a ⅕ CG intermediate wheel (B) 472. The ⅕ CG intermediate wheel (B) 472 includes an upper shaft portion, a lower shaft portion and a wheel portion. The wheel portion of the ⅕ CG intermediate wheel (B) 472 is constituted to be brought in mesh with the pinion portion of the ⅕ CG intermediate wheel (A) 470. The upper shaft portion of the ⅕ CG intermediate wheel (B) 472 is rotatably integrated to a ⅕ CG intermediate wheel (B) upper bearing portion 106gc (refer to a view of a train wheel bridge, mentioned later) provided at the train wheel bridge (A) 106. The lower shaft portion of the ⅕ CG intermediate wheel (B) 472 is rotatably integrated to a ⅕ CG intermediate wheel (B) lower bearing portion 102gc (refer to a view of a main plate, mentioned later) provided at the main plate 102. Therefore, the ⅕ CG intermediate wheel (B) 472 is rotatably arranged between the train wheel bridge (A) 106 and the main plate 102.

The ⅕ CG wheel 476 includes an upper shaft portion 476a, an abacus bead portion 476b provided at a lower shaft portion thereof, a middle shaft portion 476c and a wheel portion 476d. The wheel portion 221d of the ⅕ CG wheel 476 is constituted to be brought in mesh with the pinion portion 220c of the ⅕ CG intermediate wheel (B) 472. The upper shaft portion 476 of the ⅕ CG wheel 476 is rotatably integrated to the ⅕ CG wheel upper bearing portion 106c provided at the train wheel bridge (A) 106. The ⅕ CG upper bearing portion 106c used in the movement 400 is the same as the second wheel & pinion upper bearing portion for side 106c used in the above-described movement 100. The abacus bead portion 476b of the ⅕ CG wheel 476 is rotatably arranged to inside of a center hole of a cannon pinion for center 424b. The rotation center of the ⅕ CG wheel 476 is the main plate center 300. The ⅕ CG wheel 476 is constituted to rotate by one step per ⅕ second. A ⅕ second chronograph hand 475 is attached to the ⅕ CG wheel 476. The ⅕ second chronograph hand 475 constitutes a ⅕ second chronograph indicating member (⅕ CG indicating member).

In the movement 400, the second wheel & pinion hold spring for side 231 used in the above-described movement 100 is not used.

As a modified example, by changing the specification of IC, the step motor and the train wheel, in place of the ⅕ CG wheel 476 rotated by one step per ⅕ second, a 1 second CG wheel rotated by one step per 1 second, or a ½ CG wheel rotated by one step per ½ second or a ¼ CG wheel rotated by one step per ¼ second or the like can be provided.

(2•5) Constitution of Main Plate

In reference to FIG. 4, the minute-counting wheel lower bearing portion 102k is disposed at a position in the main plate 102, above the main plate reference horizontal axis line 304 and between the main plate center 300 and the outer shape portion 306 of the main plate 102 disposed in “6 o'clock direction” of the movement 100.

The ⅕ second rotor lower bearing portion 102a, the ⅕ CG intermediate wheel (A) lower bearing portion 102fc, and the ⅕ CG intermediate wheel (B) lower bearing portion 102gc are arranged at the third region 330 in the main plate 102.

The chronograph hour/minute rotor lower bearing portion 102f, the chronograph hour/minute fifth wheel & pinion lower bearing portion 102g, the minute-counter intermediate wheel (A) lower bearing portion 102h, the minute-counter intermediate wheel (B) lower bearing portion 102j, the hour-counter intermediate wheel (A) lower bearing portion 102m and the hour-counter intermediate wheel (B) lower bearing portion 102n are arranged at the third region 330 in the main plate 102.

The hour-counting wheel lower bearing portion 102p is disposed at a portion in the main plate 102, above the main plate reference vertical axis line 302 and between the main plate center 300 and the outer shape portion 309 of the main plate 102 disposed in “9 o'clock direction” of the movement 100.

The time rotor (B) lower bearing portion 102r, the hour fifth wheel & pinion (B) lower bearing portion 102s, the fourth wheel & pinion lower bearing portion for center 102cc, the third wheel & pinion lower bearing portion for center 102dc, the intermediate small second wheel (A) lower bearing portion 102t, the intermediate small second wheel (B) lower bearing portion 102u are arranged at the fourth region 340 in the main plate 102.

The small second wheel lower bearing portion 102v is disposed at a position in the main plate 102, above the main plate reference horizontal axis line 304 and between the main plate center 300 and the outer shape portion 312 of the main plate 102 disposed in “12 o'clock direction” of the movement 100.

The guide pin 170p is arranged at the first region 310. The guide pin 172p is arranged at the fourth region 340.

By constituting in this way, the main plate 102 used in the movement 400 can be made the same as the main plate 102 used in the movement 100. That is, the main plate can be used for the movement 400 as well as for the movement 100.

(2•6) Constitution of Train Wheel Bridge

(2•6) Constitutions of Train Wheel Bridge (A) and Train Wheel Bridge (B)

In reference to FIG. 5, the ⅕ second rotor upper bearing portion 106a, the ⅕ CG intermediate wheel (A) upper bearing portion 102fc, and the ⅕ CG intermediate wheel (B) upper bearing portion 102gc are arranged at the third region 330 in the train wheel bridge (A) 106.

The chronograph hour/minute rotor upper bearing portion 107f and the chronograph hour/minute fifth wheel & pinion upper bearing portion 107g are arranged at the third region 330 in the train wheel bridge (B) 107.

The minute-counter intermediate wheel (A) upper bearing portion 106h, the minute-counter intermediate wheel (B) upper bearing portion 106j, the hour-counter intermediate wheel (A) upper bearing portion 106m and the hour-counter intermediate wheel (B) upper bearing portion 106n are arranged at the third region 330 in the train wheel bridge (A) 106.

The hour rotor (B) upper bearing portion 106r, the hour fifth wheel & pinion (B) upper bearing portion 102s, the fourth wheel & pinion upper bearing portion for center 102cc and the third wheel & pinion upper bearing portion for center 102dc are arranged at the fourth region 340 in the train wheel bridge (A) 106.

By constituting in this way, the train wheel bridge (A) 106 and the train wheel bridge (B) 107 used in the movement 400 can respectively be the same as the train wheel bridge (A) 106 and the train wheel bridge (B) 107 used in the above-described movement 100.

(2•7) Constitution of Back Train Wheel Bridge

In reference to FIG. 6, the minute-counting wheel upper bearing portion 108k is disposed in the back train wheel bridge 108, above the main plate reference horizontal axis line 304 and between the main plate center 300 and the outer shape portion of the back train wheel bridge 108 disposed in “16 o'clock direction” of the movement 100.

The minute-counter intermediate wheel (A) upper bearing portion 108h, the minute-counter intermediate wheel (B) upper bearing portion 108j, the hour-counter intermediate wheel (A) upper bearing portion 108m and the hour-counter intermediate wheel (B) upper bearing portion 108n are arranged at the third region 330 in the back train wheel bridge 108.

The hour-counting wheel upper bearing portion 108p is disposed at a position in the back train wheel bridge 108, above the main plate reference vertical axis line 302 and between the main plate center 300 and the outer shape portion of the back train wheel bridge 108 disposed in “9 o'clock direction” of the movement 100.

The intermediate small second wheel (A) upper bearing portion 108t and the intermediate small second wheel (B) upper bearing portion 108u are disposed at the fourth region 340 in the back train wheel bridge 108.

The small second wheel upper bearing portion 108v is disposed at a position in the back train wheel bridge 108, above the main plate reference horizontal axis line 304 and between the main plate center 300 and the outer shape portion of the back train wheel bridge 108 disposed in “12 o'clock direction of the movement 100.

By constituting in this way, the back train wheel bridge 108 used in the movement 400 can be made the same as the back train wheel bridge 108 used in the above-described movement 100. That is, the back train wheel bridge can be used for the movement 400 as well as the movement 100.

(2•8) Arrangement of Parts in Movement

Next, a preferable arrangement of parts in the movement 400 will be explained.

In reference to FIG. 1, rotation center 140c of the reset lever 140′ is arranged at the second region 320.

The train wheel setting lever 440 is arranged at the first region 310 and the fourth region 340. A position of the reset lever 140′ brought into contact with the train wheel setting lever 440 is arranged at the first region 310. A position of the train wheel setting lever 440 for setting the intermediate small second wheel (B) 434 is arranged at the fourth region 340 on the back side of the movement 400. A position of the reset lever 140′ for carrying out resetting operation is arranged at the second region 320 on the surface side of the movement 400. By constituting in this way, the train wheel setting lever 440 for firmly setting rotation of the train wheel for operating the small second hand can effectively be arranged on the surf ace side of the movement 400.

A coil block center 442c of the ⅕ second coil block 442 may be arranged at the third region 330. Rotation center of the ⅕ second rotor 446, rotation center of the ⅕ CG intermediate wheel (A) 470 and rotation center of the ⅕ CG intermediate wheel (B) 472 may be arranged at the third region 330. Rotation center of the minute wheel 226 may be arranged at the second region 320.

A coil block center 462c of the chronograph hour/minute coil block 462 maybe arranged at the third region 330. Rotation center of the chronograph hour/minute rotor 466, rotation center of the chronograph hour/minute fifth wheel & pinion 450, rotation center of the minute-counter intermediate wheel (C) 451, rotation center of the minute-counter intermediate wheel (D) 453, rotation center of the hour-counter intermediate wheel (A) 452 and rotation center of the hour-counter intermediate wheel (B) 457 may be arranged at the third region 330. The coil block center 462c of the chronograph hour/minute coil block 462 is arranged on an outer side of the coil block center 442c of the ⅕ second coil block 442 in the third region 330. Rotation center of the chronograph hour-minute rotor 466 is arranged on an outer side of rotation center of the ⅕ second rotor 446 in the third region 330.

Rotation center of the minute-counting wheel 454 is disposed at a position above the main plate reference horizontal axis line 304 and between the main plate center 300 and the outer shape portion 306 of the main plate 102 disposed in “6 o'clock direction” of the movement 400. A distance between rotation center of the minute-counting wheel 454 and the main plate center 300 is preferably 30% through 70% of a radius of a maximum outer shape portion of the main plate 102, more preferably, 45% through 55% of the radius of the maximum outer shape portion of the main plate 102 and particularly preferably, about ½ of the radius of the maximum outer shape portion of the main plate 102.

Further, rotation center of the hour-counting wheel 458 is disposed at a position above the main plate reference vertical axis line 302 and between the main plate center 300 and the outer shape portion 309 of the main plate 102 disposed in “9 o'clock direction” of the movement 400. A distance between rotational center of the hour-counting wheel 458 and the main plate center 300 is preferably 30% through 70% of the radius of the maximum outer shape portion of the main plate 102, more preferably, 45% through 55% of the radius of the maximum outer shape portion of the main plate 102 and particularly preferably about ½ of the radius of the maximum outer shape portion of the main plate 102.

A coil block center 482c of the time coil block for center 482 may be arranged at the fourth region 340. Rotation center of the time rotor (B) 486, rotation center of the time fifth wheel & pinion (B) 420, rotation center of the small second intermediate wheel (A) 432, rotation center of the small second intermediate wheel (B) 434, rotation center of the fourth wheel & pinion for center 421, and rotation center of the third wheel & pinion for center 422 may be arranged at the fourth region 340. By constituting in this way, the plurality of coil blocks and the plurality of train wheels can effectively be arranged on the surface side of the movement 400. Here, a number of parts constituting the train wheels is not limited to the above-described but one or more of transmission wheels may further be added.

Rotation center of the small second wheel 436 is disposed at a position above the main plate reference horizontal axis line 304 and between the main plate center 300 and the outer shape portion 312 of the main plate 102 disposed in “12 o'clock direction” of the movement 400. A distance between rotation center of the small second wheel 436 and the main plate center 300 is preferably 30% through 70% of the radius of the maximum outer shape portion of the main plate 102, more preferably, 45% through 55% of the radius of the maximum outer shape portion of the main plate 102 and particularly preferably, about ½ of the radius of the maximum outer shape portion of the main plate 102.

It is preferable to constitute all of the distance between rotation center of the minute-counting wheel 454 and the main plate center 300, the distance between rotation center of the hour-counting wheel 458 and the main plate center 300 and the distance between rotation center of the small second wheel 436 and the main plate center 300 to be an equal value.

(2•9) Operation of Second Embodiment

Next, an explanation will be given of operation of the second embodiment of the analog electronic timepiece (analog chronograph timepiece) according to the invention.

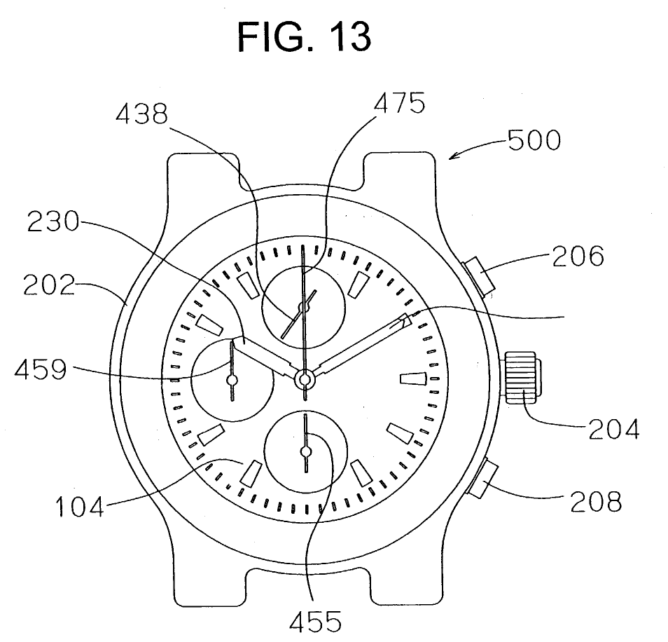

In reference to FIG. 13, a complete 500 of the center chronograph timepiece is provided with the outer case 202. The outer case 202 used in the second embodiment of the analog chronograph timepiece according to the invention may be the same as the outer case 202 used in the above-described first embodiment of the analog chronograph timepiece of the invention or may be different therefrom. The movement 400 and the dial 104 are contained in the outer case 202. The dial 104 used in the second embodiment of the analog chronograph timepiece of the invention may be the same as the dial 104 used in the above-described first embodiment of the analog chronograph timepiece of the invention or may be different therefrom.

The crown 204 is provided at the outer case 202 to rotate integrally with the hand setting stem 110. Time of the center chronograph timepiece is constituted to be able to set by pulling out the crown 204 to the first stage and rotating the crown 204. That is, when the crown 204 is pulled out to the first stage, the small second hand 438 is constituted to be able to stop and the hour hand 230 and the minute hand 232 are constituted to be able to rotate by rotating the crown 204.

The outer case 202 is provided with the start/stop button 206 for starting or stopping operation of chronograph of the center chronograph timepiece. Signals with regard to starting operation and stopping operation of the chronograph are constituted to transmit to IC 116 by operating the switch spring when the start/stop button 206 is pushed. The outer case 202 is provided with the reset button 208 for resetting operation of chronograph of the center chronograph timepiece. A signal with regard to resetting operation of chronograph is constituted to transmit to IC 116 by operating the switch spring when the reset button 208 is pushed.

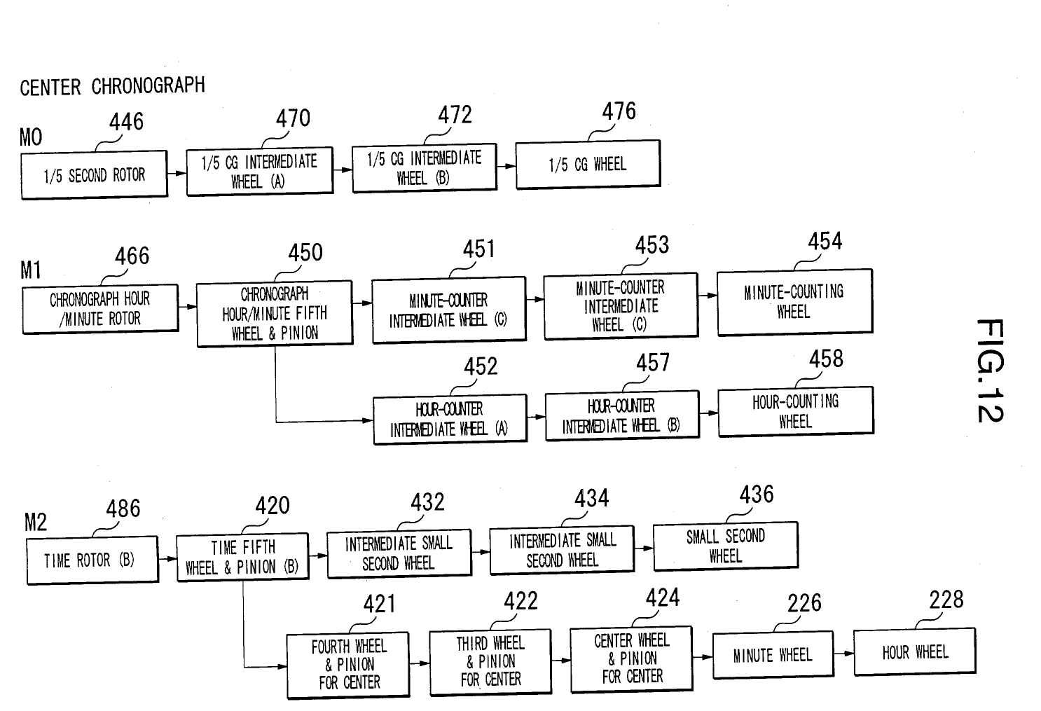

Here, operation of indicating current time will be explained. In reference to FIG. 9 through FIG. 13, time of the center chronograph timepiece is set to current time by pulling out the crown 204 to the first stage and rotating the crown 204 and the crown 204 is pushed to zero stage. Under the state, the time rotor (B) 486 is rotated and the time fifth wheel & pinion (B) 420 is rotated based on rotation of the time rotor (B) 486. The small second wheel 436 is rotated based on rotation of the time fifth wheel &pinion (B) 420 via rotation of the intermediate small second wheel (A) 432 and the intermediate small second wheel (B) 434. The small second wheel 436 is rotated by one rotation per minute and therefore, the small second hand 438 attached to the small second wheel 436 indicates “second” of current time.

Further, the center wheel & pinion for center 424 is, rotated based on rotation of the time fifth wheel & pinion (B) 420 via rotation of the fourth wheel & pinion for center 421 and the third wheel & pinion for center 422. The center wheel & pinion for center 424 is rotated by one rotation per hour and therefore, the minute hand 232 attached to the cannon pinion for center 424b of the center wheel & pinion for center 424 indicates “minute” of current time.

Further, the hour wheel 228 is rotated based on rotation of the center wheel & pinion for center 424 via rotation of the minute wheel 226. The hour wheel 228 is rotated by one rotation per 12 hours and therefore, the hour hand 234 attached to the hour wheel 228 indicates “hour” of current time.

Next, operation of measurement of chronograph will be explained. In reference to FIG. 13, in a state of stopping to reset measurement of chronograph, all of the hour chronograph hand 459, the minute chronograph hand 455 and the ⅕ second chronograph hand 475 are disposed at “zero positions (initial positions)”. That is, in the reset state, all of the hour chronograph hand 459′ the minute chronograph hand 455, the ⅕ second chronograph hand 475 are disposed at positions indicating “zero”.

In reference to FIG. 9 through FIG. 13, the chronograph measuring mode is started by pushing the start/stop button 206 to start measurement of chronograph. In the chronograph measuring mode, the chronograph hour/minute rotor 466 is rotated and the chronograph hour/minute fifth wheel & pinion 450 is rotated based on rotation of the chronograph hour/minute rotor 466. Further, the minute-counter intermediate wheel (C) 451 and the hour-counter intermediate wheel (A) 452 are rotated based on rotation of the chronograph hour/minute fifth wheel & pinion 250. The minute-counting wheel 454 is rotated based on rotation of the minute-counter intermediate wheel (C) 451 via rotation of the minute-counter intermediate wheel (D) 453. In the chronograph measuring mode, the minute chronograph hand 455 attached to the minute-counting wheel 454 indicates “minute” in elapse time.

Further, the hour-counting wheel 458 is rotated based on rotation of the hour-counter intermediate wheel (A) 452 via rotation of the hour-counter intermediate wheel (B) 457. In the chronograph measuring mode, the hour chronograph hand 459 attached to the hour-counting wheel 458 indicates “hour” in elapse time.

Further, in the chronograph measuring mode, the ⅕ second rotor 446 is rotated and the ⅕ CG intermediate wheel (A) 470 is rotated based on rotation of the ⅕ second rotor 446. The ⅕ CG wheel 476 is rotated based on rotation of the ⅕ CG intermediate wheel (A) 470 via rotation of the ⅕ CG intermediate wheel (B) 472. In the chronograph measuring mode, the ⅕ second chronograph hand 475 attached to the ⅕ CG wheel 476 is operated to indicate “second” in elapse time by “⅕ second unit”.

Further, in the chronograph measuring mode, when the start/stop button 206 is pushed, measurement of chronograph can be stopped. In the state of stopping to measure chronograph, the hour chronograph hand 459 is stopped in a state of indicating “hour” in elapse time, the minute chronograph hand 455 is stopped in a state of indicating “minute” in elapse time and the ⅕ second chronograph hand 475 is stopped in a state of indicating “second” in elapse time by “⅕ second unit”.

In the state of stopping to measure chronograph, when the reset button 208 is pushed, all of the hour chronograph hand 459, the minute chronograph hand 455 and the ⅕ second chronograph hand 475 return to positions indicating “zero” (refer to FIG. 8).

(3) Other Embodiment

Next, other embodiment of the invention will be explained.

The following explanation will mainly be given of a point of other embodiment of the invention different from the first embodiment of the invention and a point of other embodiment different from the second embodiment of the invention. Therefore, with regard to a portion other than content described below, the above-described explanation with regard to the first embodiment of the invention and the above-described explanation with regard to the second embodiment of the invention will be applied thereto.

(3•1) Constitution of Movement of Side Chronograph Timepiece

In the above-described movement 100 of the side chronograph timepiece, although parts constituting the movement 100 are preferably arranged to constitute a structure shown in FIG. 1 relative to the main plate reference vertical axis line 302, the parts constituting the movement may be arranged to constitute a structure in mirror symmetry with the structure shown in FIG. 1 relative to the main plate reference vertical axis line 302.

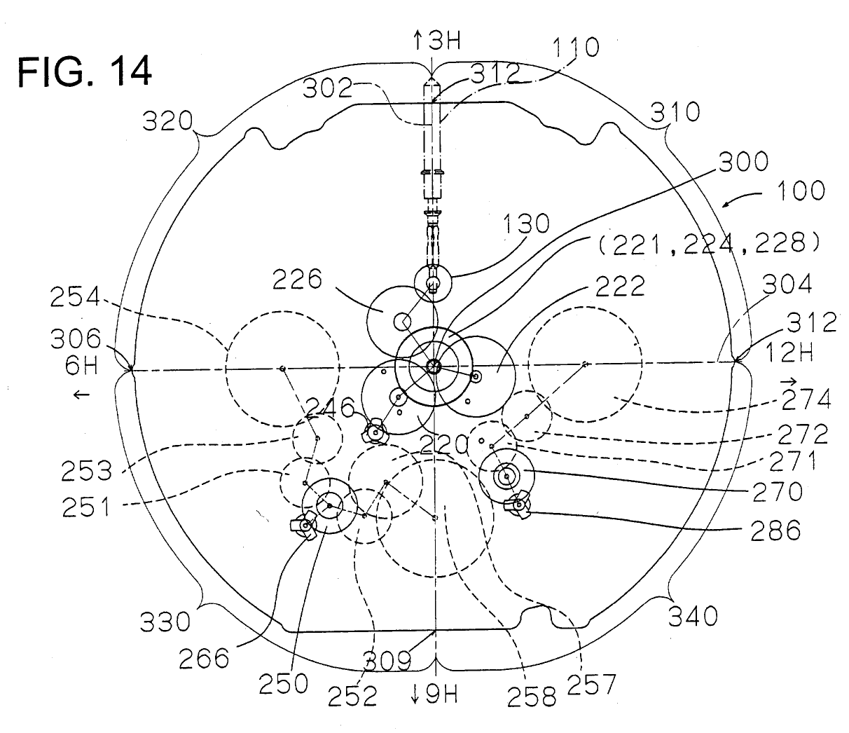

That is, in reference to FIG. 1 and FIG. 14, in the movement 100, the coil block center 242c of the time coil block for side 242 is arranged at the third region 330. Rotation center of the time rotor (A) 246 and rotation center of the time fifth wheel & pinion (A) 220 are arranged at the third region 330. Rotation center of the third wheel & pinion for side 222 is arranged at the fourth region 340. Rotation center of the minute wheel 226 is arranged at the second region 320.

The coil block center 262c of the chronograph minute/second coil block 262 is arranged at the third region 330. Rotation center of the chronograph minute/second rotor 266, rotation center of the chronograph minute/second fifth wheel & pinion 250, rotation center of the second-counter intermediate wheel (A) 251, rotation center of the minute-counter intermediate wheel (A) 252, rotation center of the second-counter intermediate wheel (B) 253 and rotation center of the minute-counter intermediate wheel (B) 257 are arranged at the third region 330. The coil block center 262c of the chronograph minute-second coil block 262 is arranged on the outer side of the coil block center 242c of the time coil block for side 242 in the third region 330. Rotation center of the chronograph minute/second rotor 266 is arranged on the outer side of rotation center of the time rotor (A) 246 in the third region 330.

Rotation center of the second-counting wheel 254 is disposed at a position above the main plate reference horizontal axis line 304 and between the main plate center 300 and the outer shape portion 306 of the main plate 102 disposed in “6 o'clock direction” of the movement 100.

Further, rotation center of the minute-counting wheel 258 is disposed at a position above the main plate reference vertical axis line 302 and between the main plate center 300 and the outer shape portion 309 of the main plate 302 disposed in “9 o'clock direction” of the movement 100.

The coil block center 282c of the 1/10 second coil block 282 is arranged at the fourth region 340. Rotation center of the 1/10 second rotor 286, rotation center of the 1/10 second fifth wheel & pinion 270, rotation center of the 1/10 second-counter intermediate wheel (A) 271 and rotation center of the 1/10 second-counter intermediate wheel (B) 272 are arranged at the fourth region 340.

Rotation center of the 1/10 second-counting wheel 274 is disposed at a position above the main plate reference horizontal axis line 304 and between the main plate center 300 and the outer shape portion 312 of the main plate 102 disposed in “12 o'clock direction” of the movement 100.

All of the distance between rotation center of the second-counting wheel 254 and the main plate center 300, the distance between rotation center of the minute-counting wheel 258 and the main plate center 300 and the distance between rotation center of the 1/10 second-counting wheel 274 and the main plate center 300 are constituted to be an equal value.

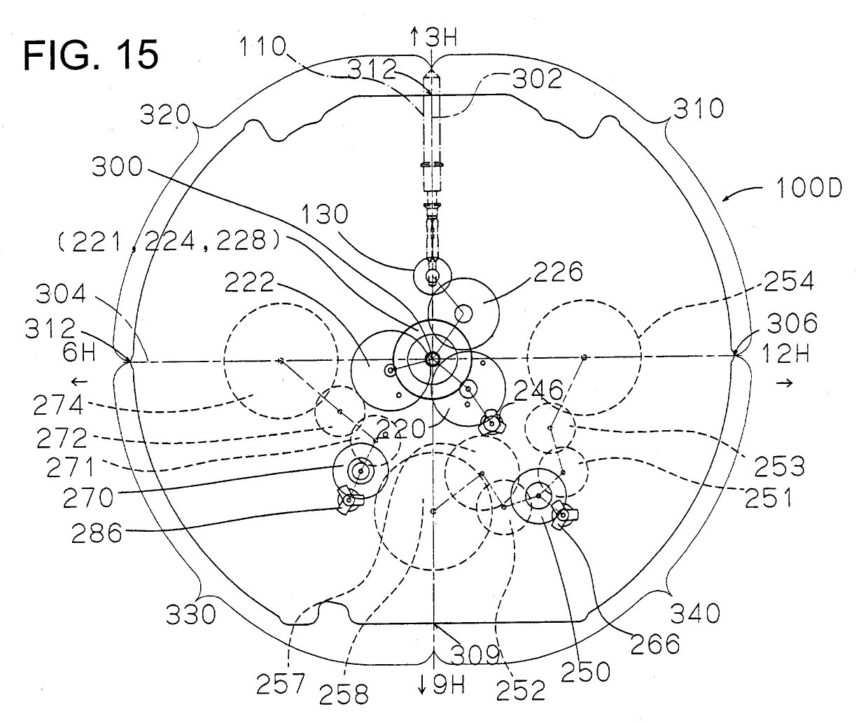

In contrast thereto, in reference to FIG. 15, there may be constructed a constitution in a movement 100D such that rotation center of the time rotor (A) 246 and rotation center of the time fifth wheel & pinion (A) 220 are arranged at the fourth region 340, rotation center of the third wheel & pinion for side 222 is arranged at the third region 330, rotation center of the minute wheel 226 is arranged at the first region 310, rotation center of the chronograph minute/second rotor 266, rotation center of the chronograph minute/second fifth wheel & pinion 250, rotation center of the second-counter intermediate wheel (A) 251, rotation center of the minute-counter intermediate wheel (A) 252, rotation center of the second-counter intermediate wheel (B) 253 and rotation center of the minute-counter intermediate wheel (B) 257 are arranged at the fourth region 340 and rotation center of the 1/10 second rotor 286, rotation center of the 1/10 second fifth wheel & pinion 270, rotation center of the 1/10 second-counter intermediate wheel (A) 271 and rotation center of the 1/10 second-counter intermediate wheel (B) 272 are arranged at the third region 330.

Further, in the movement 100D, rotation center of the second-counting wheel 254 is disposed at a position above the main plate reference horizontal axis line 304 and between the main plate center 300 and the outer shape portion 312 of the main plate 102d disposed in “12 o'clock direction” of the movement 100, rotation center of the minute-counting wheel 258 is disposed at a position above the main plate reference vertical axis line 302 and between the main plate center 300 and the outer shape portion 309 of the main plate 102d disposed in “9 o'clock direction” of the movement 100D and rotation center of the 1/10 second-counting wheel 274 is disposed at a position above the main plate reference horizontal axis line 304 and between the main plate center 300 and the outer shape portion 306 of the main plate 102D disposed in “6 o'clock direction” of the movement 100.

(3•2) Constitution of Movement of Center Chronograph Timepiece

In the above-described movement 400 of the center chronograph timepiece, although parts constituting the movement 400 are preferably arranged to constitute a structure shown in FIG. 9 relative to the main plate reference vertical axis line 302, the parts constituting the movement may be arranged to constitute a structure in mirror symmetry with the structure shown in FIG. 9 relative to the main plate reference vertical axis line 302.

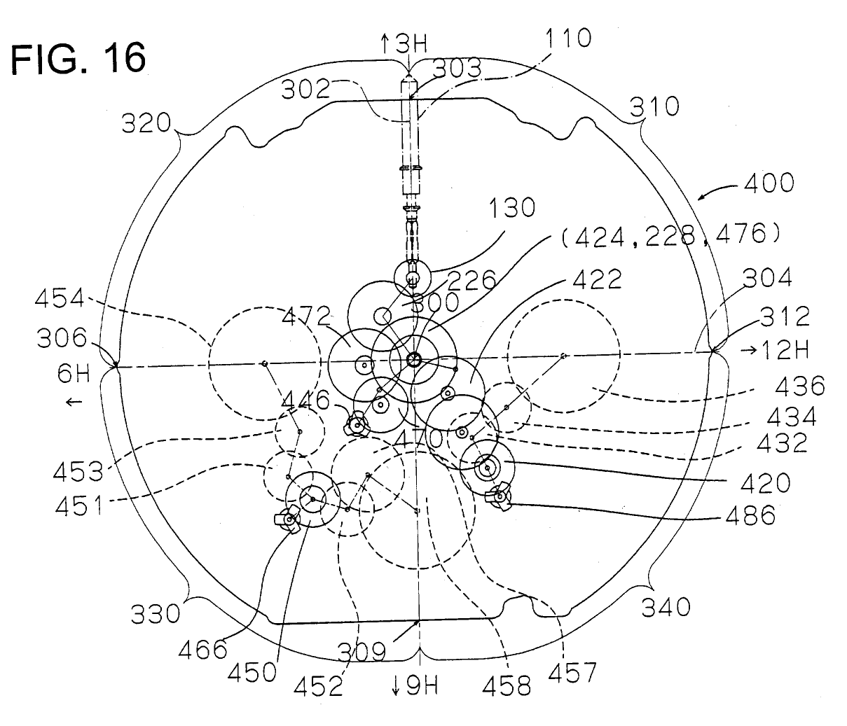

That is, in reference to FIG. 9 and FIG. 16, in the movement 400, the coil block center 442c of the ⅕ second coil block 442 is arranged at the third region 330. Rotation center of the ⅕ second rotor 446, rotation center of the ⅕ CG intermediate wheel (A) 470 and rotation center of the ⅕ CG intermediate wheel (B) 472 are arranged at the third region 330. Rotation center of the minute wheel 226 is arranged at the second region 320.

The coil block center 462c of the chronograph hour/minute coil block 462 is arranged at the third region 330. Rotation center of the chronograph hour/minute rotor 466, rotation center of the chronograph hour/minute fifth wheel & pinion 450, rotation center of the minute/counter intermediate wheel (C) 451, rotation center of the minute-counter intermediate wheel (D) 453, rotation center of the hour-counter intermediate wheel (A) 452 and rotation center of the hour-counter intermediate wheel (B) 457 are arranged at the third region 330. The coil block center 462c of the chronograph hour/minute coil block 462 is arranged on the outer side of the coil block center 442c of the ⅕ second coil block 442 in the third region 330. Rotation center of the chronograph hour/minute rotor 466 is arranged on the outer side of rotation center of the ⅕ second rotor 446 in the third region 330.

Rotation center of the minute-counting wheel 454 is disposed at a position above the main plate reference horizontal axis line 304 and between the main plate center 300 and the outer shape portion 306 of the main plate 102 disposed in “6 o'clock direction” of the movement 400.

Further, rotation center of the hour-counting wheel 458 is disposed at a position above the main plate reference vertical axis line 302 and between the main plate center 300 and the outer shape portion 309 of the main plate 102 disposed in “9 o'clock direction” of the movement 400.

The coil block center 482c of the time coil block for center 482 is arranged at the fourth region 340. Rotation center of the time rotor (B) 486, rotation center of the time fifth wheel & pinion (B) 420, rotation center of the intermediate small second wheel (A) 432, rotation center of the intermediate small second wheel (B) 434, rotation center of the fourth wheel & pinion for center 421 and rotation center of the third wheel & pinion for center 422 are disposed at the fourth region 340.

Rotation center of the small second wheel 436 is disposed at a position above the main plate reference horizontal axis line 304 and between the main plate center 300 and the outer shape portion 312 of the main plate 102 disposed in “12 o'clock direction” of the movement 400.

All of the distance between rotation center of the minute-counting wheel 454 and the main plate center 300, the distance between rotation center of the hour-counting wheel 458 and the main plate center 300 and the distance between rotation center of the small second wheel 436 and the main plate center 300 are constituted to be an equal value.

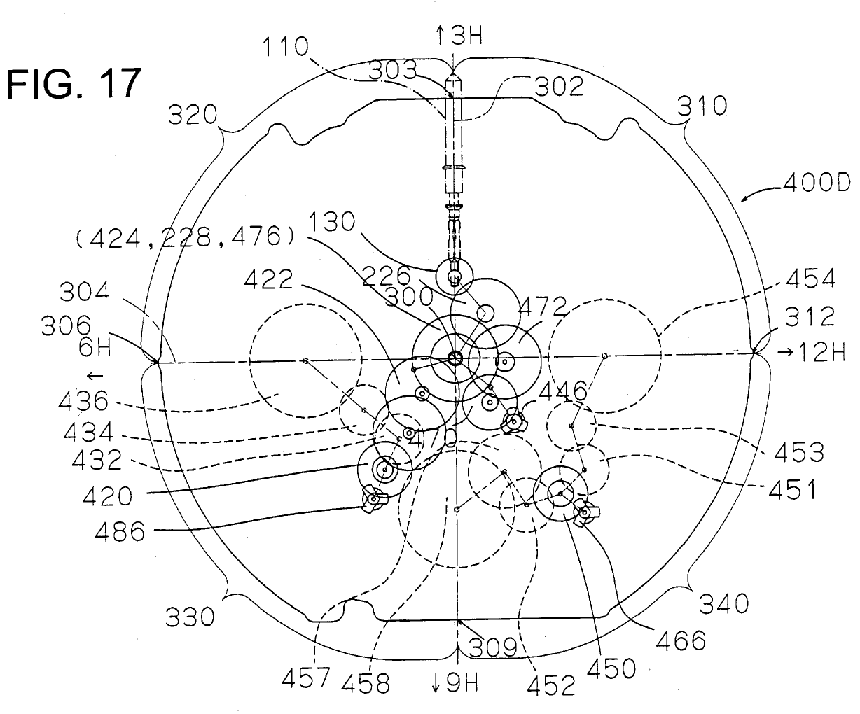

In contrast thereto, in reference to FIG. 17, in the movement 400D, there may be constructed a constitution such that rotation center of the ⅕ second rotor 446, rotation center of the ⅕ CG intermediate wheel (A) 470, and rotation center of the ⅕ CG intermediate wheel (B) 472 are arranged at the second region 320, rotation center of the minute wheel 226 is arranged at the first region 310, rotation center of the chronograph hour/minute rotor 466, rotation center of the chronograph hour/minute fifth wheel & pinion 450, rotation center of the minute-counter intermediate wheel (C) 451, rotation center of the minute-counter intermediate wheel (D) 453, rotation center of the hour-counter intermediate wheel (A) 452 and rotation center of the hour-counter intermediate wheel (B) 457 are arranged at the second region 320, rotation center of the time rotor (B) 486, rotation center of the time fifth wheel & pinion (B) 420, rotation center of the intermediate small second wheel (A) 432, rotation center of the intermediate small second wheel (B) 434, rotation center of the fourth wheel & pinion for center 421 and rotation center of the third wheel & pinion for center 422 are arranged at the third region 330.

In the movement 400D, rotation center of the minute-counting wheel 454 is disposed at a position above the main plate reference horizontal axis line 304 and between the main plate center 300 and the outer shape portion 312 of the main plate 102D disposed in “12 o'clock direction” of the movement 400D, rotation center of the hour-counting wheel 458 is disposed at a position above the main plate reference vertical axis line 302 and between the main plate center 300 and the outer shape portion 309 of the main plate 102D disposed in “9 o'clock direction” of the movement 400D and rotation center of the small second wheel 436 is disposed at a position above the main plate reference horizontal axis line 304 and between the main plate center 300 and the outer shape portion 312 of the main plate 102D disposed in “12 o'clock direction” of the movement 400D.

(4) Structure of Train Wheel Setting Lever

(4•1) First Type of Train Wheel Setting Lever

Next, a first type of a train wheel setting lever will be explained in details in the second embodiment of the analog electronic timepiece according to the invention.

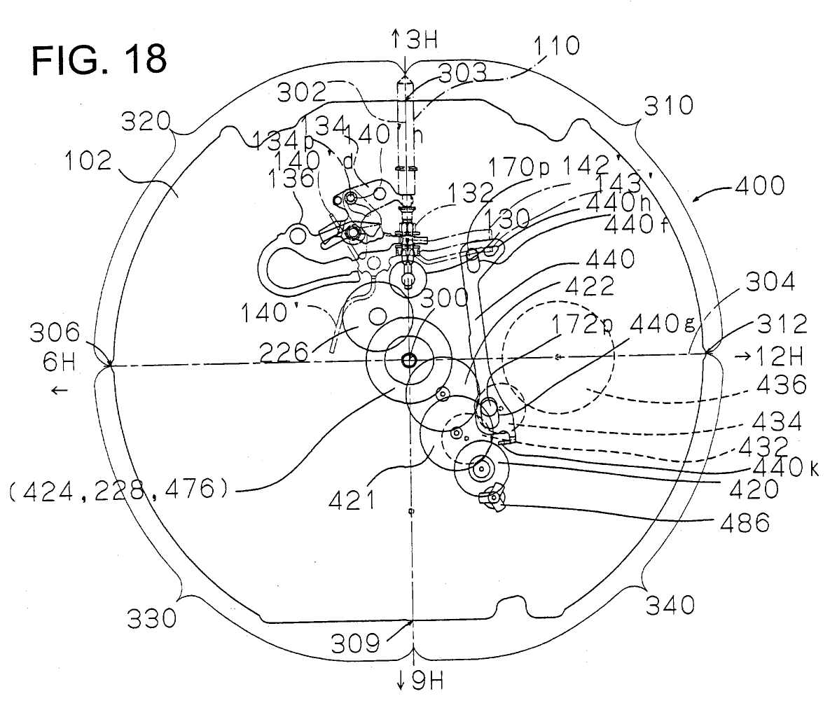

In reference to FIG. 9 and FIG. 18, as described above, “surface side” of the movement 400 of the analog electronic timepiece is arranged with the time train wheel portion for center, the switching apparatus and the like. The time train wheel portion for center includes the time motor for center and the train wheel for center. The time train wheel portion for center is constituted to rotate by rotation of the time motor for center to indicate “hour” in current time by the hour hand 230, indicate “minute” in current time by the minute hand 232 and indicate “second” in current time by the small second hand 434.

The time rotor (B) 486 is constituted to rotate by, for example, 180 degrees per second. The time fifth wheel & pinion (B) 420 is constituted to rotate based on rotation of the time rotor (B) 486. The fourth wheel & pinion for center 421 and the intermediate small second wheel 432 are constituted to rotate based on rotation of the time fifth wheel & pinion (B) 420. The center wheel & pinion for center 424 is constituted to rotate based on rotation of the fourth wheel & pinion for center 421 via rotation of the third wheel & pinion for center 422. The center wheel & pinion for center 424 is constituted to rotate by one rotation per hour. The minute hand 232 is attached to the cannon pinion for center 424b of the center wheel & pinion for center 424. The hour wheel 228 is constituted to rotate based on rotation of the center wheel & pinion for center 424 via rotation of the minute wheel 226. The hour wheel 228 is constituted to rotate by one rotation per 12 hours. The intermediate small second wheel (A) 432 is constituted to rotate based on rotation of the time fifth wheel & pinion (B) 420. The small second wheel 436 is constituted to rotate based on rotation of the intermediate small second wheel (A) 432 via rotation of the intermediate small second wheel (B) 434. The small second hand 438 is attached to the small second wheel 436. The small second hand 438 constitutes the second indicating member.

Rotation center of the small second wheel 436 is disposed at a position above the main plate reference horizontal axis line 304 and between the main plate center 300 and the outer shape portion 312 of the main plate 402 disposed in “12 o'clock direction” of the movement 400. The distance between rotation center of the small second wheel 436 and the main plate center 300 is about ½ of the radius of the maximum outer shape portion of the main plate 402.

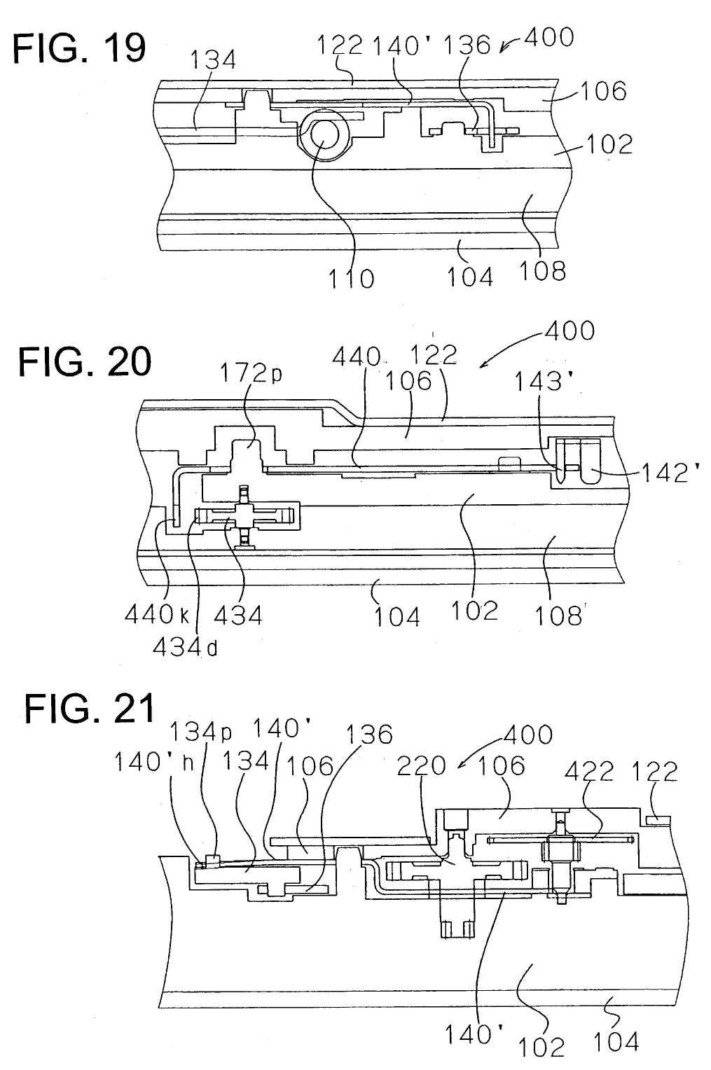

In reference to FIG. 18 through FIG. 21, the reset lever 140′ includes the reset conduction spring 140d for carrying out resetting operation, the train wheel setting lever holding portion 142 for holding the train wheel setting lever 440 and the operation spring 143 for operating the train wheel setting lever 440. The setting lever 134 is provided with the operation pin 134p inserted into an operation hole 140h of the reset lever 140′. When the hand setting stem 110 is pulled out from the zero stage to the first stage, by rotating the setting lever 134, the yoke 136 is constituted to rotate thereby. Further, when the hand setting stem 110 is pulled out from the zero stage to the first stage, by rotating the setting lever 134, the reset lever 140′ is constituted to rotate thereby. In the state of pulling out the hand setting stem 110 to the first stage, the analog electronic timepiece is constituted to be able to reset by conducting the reset conduction spring 140d of the reset lever 140′ to the reset pattern of the circuit block.

Further, the train wheel bridge setting lever 440 is constituted to move linearly by rotating the setting lever 134 and the reset lever 140′ when the hand setting stem 110 is pulled out from the zero stage to the first stage. The train wheel setting lever 440 is constituted to be able to set rotation of the intermediate small second wheel (B) 434 in the state of pulling out the hand setting stem 110 to the first stage. The train wheel setting lever 440 includes the guide window portions 440f and 440g, the operation window portion 440h and the setting portion 440k for setting rotation of the intermediate small second wheel (B) 434. The guide window portion 440f of the train wheel setting lever 440 is guided by the guide pin 170p of the main plate 102. The guide window portion 440g of the train wheel setting lever 440 is guided by the guide pin 172p of the main plate 102. Therefore, the train wheel setting lever 440 is integrated to the main plate 102 to be able to move linearly relative to the main plate 102. According to the constitution shown in FIG. 18, the train wheel setting lever 440 is arranged not to overlap parts attached with hands, that is, the hour wheel 228, the center wheel & pinion for center 424, the small second wheel 436 and the ⅕ CG wheel 476. According to the constitution, the train wheel setting lever 440 is arranged not to overlap the parts attached with the hands and therefore, the thickness of the electronic timepiece can be thinned.

When the hand setting stem is pulled out to the first stage, the reset lever 140′ is rotated and by rotating the operation spring 143, the train wheel setting lever 440 can linearly be moved along the surface of the main plate 102 by being guided by the guide pins 170p and 172p. When the train wheel setting lever 440 is linearly moved, the setting portion 440k of the setting lever 440 is brought into contact with the wheel portion 434d of the intermediate small second wheel (B) 434, thereby, rotation of the intermediate small second wheel (B) 434 can be set. According to the constitution, since the train wheel setting lever 440 is linearly moved, the setting portion 440k of the train wheel setting lever 440 is brought into contact with the wheel portion 434d of the intermediate small second wheel (B) 434 by being operated from a direction orthogonal to the wheel portion 434d. Therefore, when the intermediate small second wheel (B) 434 is set, there is rarely a concern of rotating the intermediate small second wheel (B) 434 by the train wheel setting lever 440. Rotation center of the reset lever 140′ is arranged at the second region 320. Portions of the train wheel setting lever 440 and the reset lever 140′ brought into contact with each other and the guide pin 170p are arranged at the first region 310. A portion of the setting portion 440k of the train wheel setting lever 440 which is brought into contact with the wheel portion 434d of the intermediate small second wheel (B) 434 and the guide pin 172p are arranged at the fourth region 340.

(4•2) Second Type of Train Wheel Setting Lever

Next, a second type of train wheel setting lever will be explained in details in the second embodiment of the analog electronic timepiece according to the invention.

The following explanation will mainly be given of a point of the second type of the train wheel setting lever according to the second embodiment of the invention which differs from the first type of the train wheel setting lever according to the second embodiment of the invention. Therefore, the above-described explanation with regard to the first type of the train wheel setting lever according to the second embodiment of the invention will be applied to a portion other than content described below.

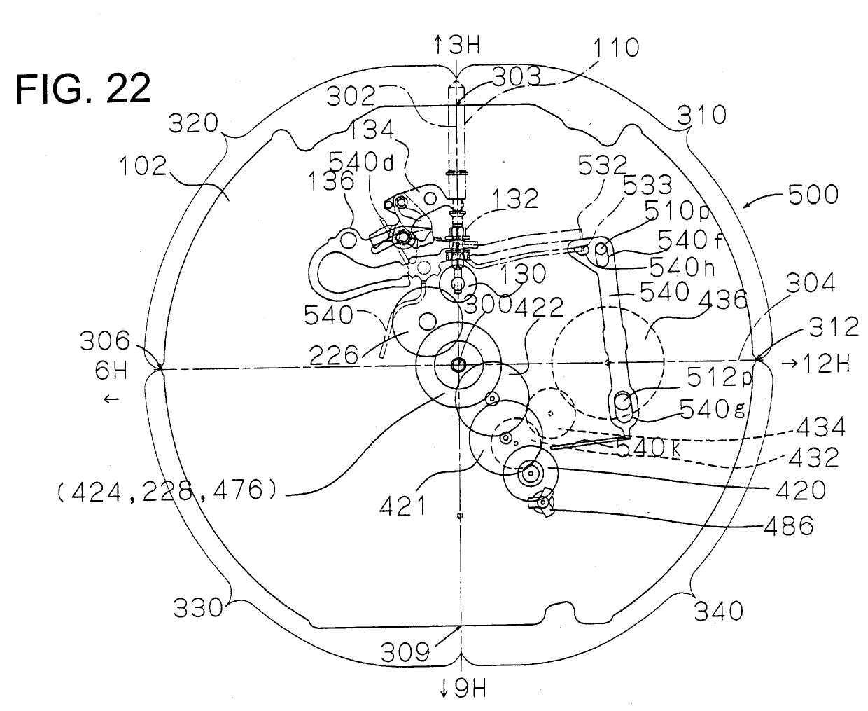

In reference to FIG. 22, as described above, “surface side” of a movement 500 of the analog electronic timepiece is arranged with a time train wheel portion for center, a switching apparatus and the like. The small second hand 438 is attached to the small second wheel 436. Rotation center of the small second wheel 436 is disposed at a position above the main plate reference horizontal axis line 304 and between the main plate center 300 and the outer shape portion 312 of the main plate 502 disposed in “12 o'clock direction” of the movement 500. The distance between rotation center of the small second wheel 436 and the main plate center 300 is about ½ of the radius of the maximum outer shape portion of the main plate 502.

A reset lever 530 includes a reset conduction spring 530d for carrying out resetting operation a train wheel setting lever holding portion 532 for holding a train wheel setting lever 540 and an operation spring 533 for operating the train wheel setting lever 540. When the hand setting stem 110 is pulled out to the first stage, by rotating the setting lever 134, the reset lever 530 is also rotated. In the state of pulling out the hand setting stem 110 to the first stage, the analog electronic timepiece can be reset by conducting a reset conduction spring 530d of the reset lever 530 to the reset pattern of the circuit block.

Further, the train wheel setting lever 540 is constituted to move linearly by rotating the setting lever 134 and the reset lever 530 when the hand setting stem 110 is pulled to the first stage. The train wheel setting lever 540 is constituted to be able to set rotation of the intermediate small second wheel (B) 434 in the state of pulling out the hand setting stem 110 to the first stage. The train wheel setting lever 540 includes guide window portions 540f and 540g, an operation window portion 540h and a setting portion 540k for setting rotation of the intermediate small second wheel (B) 434. The guide window portion 540f of the train wheel setting lever 540 is guided by a guide pin 510p of a main plate 502. The guide window portion 540g of the train wheel setting lever 540 is guided by a guide pin 512p of the main plate 502. Therefore, the train wheel setting lever 540 is integrated to the main plate 502 to be able to move linearly relative to the main plate 502. According to the constitution shown in FIG. 22, the train wheel setting lever 540 is arranged such that a portion thereof overlaps the small second wheel 436. According to the constitution, the train wheel setting lever is arranged to overlap the small second wheel 436 and therefore, the size of the electronic timepiece can be reduced.

When the hand setting stem is pulled out to the first stage, the reset lever 530 is rotated and by rotating the operation spring 533, the train wheel setting lever 540 can linearly be move along the surface of the main plate 502 by being guided by the guide pins 510p and 512p. When the train wheel setting lever 540 is linearly moved, the setting portion 540k of the train wheel setting lever 540is brought into contact with the wheel portion 434d of the intermediate small second wheel (B) 434, thereby, rotation of the intermediate small second wheel (B) 434 can be set. Rotation center of the reset lever 530 is arranged at the second region 320. Portions of the train wheel setting lever 540 and the reset lever 530 brought into contact with each other and the guide pin 510p are arranged at the first region 310. A portion of the setting portion 540k of the train wheel setting lever 540 which is brought into contact with the wheel portion 434d of the intermediate small second wheel (B) 434 and the guide pin 512p are arranged at the fourth region 340.

(4•3) Third Type of Train Wheel Setting Lever

Next, a third type of a train wheel setting lever will be explained in details in the second embodiment of the analog electronic timepiece of the invention. The following explanation will mainly be given of a point of the third type of the train wheel setting lever according to the second embodiment of the invention which differs from the first type of the train wheel setting lever according to the second embodiment of the invention. Therefore, the above-described explanation with regard to the first type of the train wheel setting lever according to the second embodiment of the invention will be applied to a portion other than content described below.

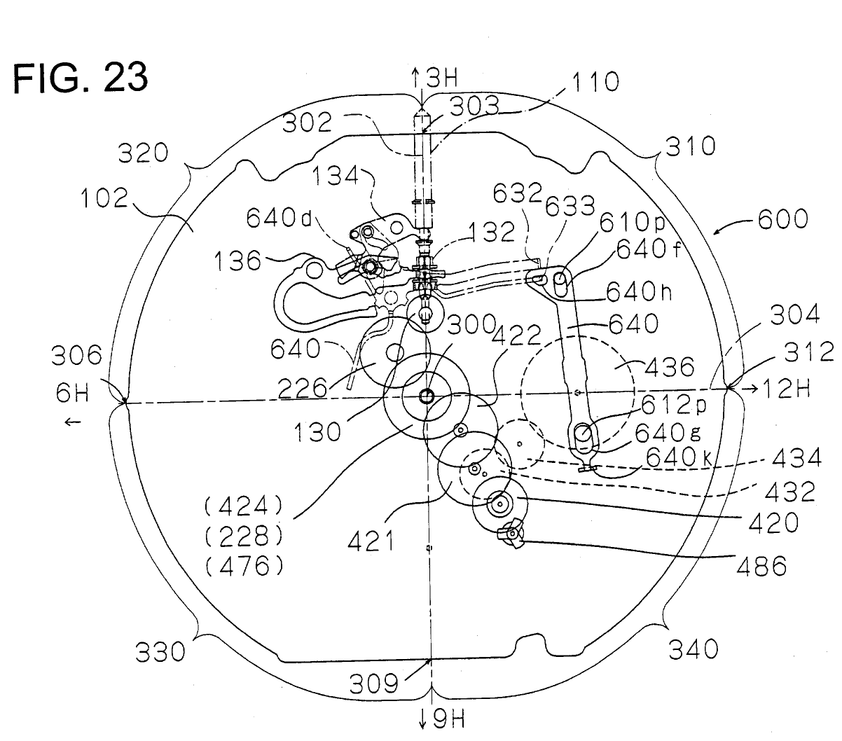

In reference to FIG. 23, as described above, “surface side” of the movement 600 of the analog electronic timepiece is arranged with the time train wheel portion for center, the switching apparatus and the like. The small second hand 438 is attached to the small second wheel 436. Rotation center of the small second wheel 436 is disposed at a position above the main plate reference horizontal axis line 304 and between the main plate-center 300 and the outer shape portion 312 of the main plate 602 disposed in “12 o'clock direction” of the movement 600. The distance between rotation center of the small second wheel 436 and the main plate center 300 is about ½ of the radius of the maximum outer shape portion of the main plate 602.

A reset lever 630 includes a reset conduction spring 630d for carrying out resetting operation, a train wheel setting lever holding portion 632 for holding a train wheel setting lever 640 and an operation spring 633 for operating the train wheel setting lever 640. When the hand setting stem 110 is pulled out to the first stage, by rotating the setting lever 134, the reset lever 630 is also rotated. In the state of pulling out the hand setting stem 110 to the first stage, the analog electronic timepiece can be reset by conducting the reset conduction spring 530d of the reset lever 630 to the reset pattern of the circuit block.

Further, the train wheel setting lever 640 is constituted to move linearly by rotating the setting lever 134 and the reset lever 630 when the hand setting stem 110 is pulled out to the first stage. The train wheel setting lever 640 is constituted to be able to set rotation of the small second wheel 436 in the state of pulling out the hand setting stem 110 to the first stage. The train wheel setting lever 640 includes guide window portions 640f and 640g, an operation window portion 640h and a setting portion 640k for setting rotation of the small second wheel 436. The guide window portion 640f of the train wheel setting lever 640 is guided by a guide pin 610p of a main plate 602. The guide window portion 640g of the train wheel setting lever 640 is guided by a guide pin 612p of the main plate 602. Therefore, the train wheel setting lever 640 is integrated to the main plate 602 to be able to move linearly relative to the main plate 602. According to the constitution shown in FIG. 23, the train wheel setting lever 640 is arranged such that a portion thereof overlaps the small second wheel 436. According to the constitution, the train wheel setting lever is arranged to overlap the small second wheel 436 and therefore, the size of the electronic timepiece can be reduced.

When the hand setting stem is pulled out to the first stage, the reset lever 630 is rotated and by rotating the operation spring 633, the train wheel setting lever 640 can be moved linearly along the surface of the main plate 602 by being guided by the guide pins 610p and 612p. When the train wheel setting lever 640 is linearly moved, the setting portion 640k of the train wheel setting lever 640 is brought into contact with the wheel portion 436d of the small second wheel 436, thereby, rotation of the small second wheel 436 can be set.

Rotation center of the reset lever 630 is arranged at the second region 320. Portions of the train wheel setting lever 640 and the reset lever 630 brought into contact with each other and the guide pin 610p are arranged at the first region 310. A portion of the setting portion 640k of the train wheel setting lever 640 which is brought into contact with the wheel portion 436d of the small second wheel 436 and the guide pin 612p are arranged at the fourth region 340.

(4•4) Fourth Type of Train Wheel Setting Lever

Next, a fourth type of a train wheel setting lever will be explained in details in the second embodiment of the analog electronic timepiece of the invention. The following explanation will mainly be given of a point of the fourth type of the train wheel setting lever according to the second embodiment of the invention which differs from the first type of the train wheel setting lever according to the second embodiment of the invention. Therefore, the above-described explanation with regard to the first type of the train wheel setting lever according to the second embodiment of the invention will be applied to a portion other than content described below.

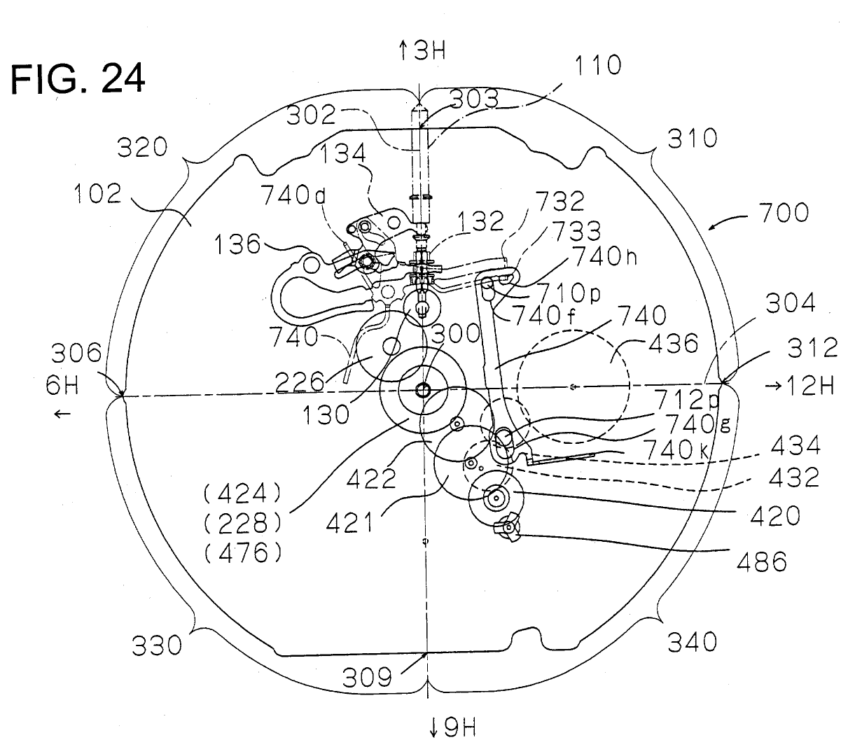

In reference to FIG. 24, as described above, “surface side” of a movement 700 of the analog electronic timepiece is arranged with the time train wheel portion for center, the switching apparatus and the like. The small second hand 438 is attached to the small second wheel 436. Rotation center of the small second wheel 436 is disposed at a position above the main plate reference horizontal axis line 304 and between the main plate center 300 and the outer shape portion 312 of a main plate 702 disposed in “12 o'clock direction” of the movement 700. The distance between rotation center of the small second wheel 436 and the main plate center 300 is about ½ of the radius of the maximum outer shape portion of the main plate 702.

A reset lever 730 includes a reset conduction spring 730d for carrying out resetting operation, a train wheel setting lever holding portion 732 for holding a train wheel setting lever 740, and an operation spring 733 for operating the train wheel setting lever 740. When the hand setting stem 110 is pulled to the first stage, the reset lever 730 is also rotated by rotating the setting lever 134. In the state of pulling out the hand setting stem 110 to the first stage, the analog electronic timepiece can be reset by conducting the reset conduction spring 730d of the reset lever 730 to the reset pattern of the circuit block.

Further, the train wheel setting lever 740 is constituted to be able to move linearly by rotating the setting lever 134 and the reset lever 730. The train wheel setting lever 740 is constituted to be able to set rotation of the small second wheel 436 in the state of pulling out the hand setting stem 110 to the first stage. The train wheel setting lever 740 includes guide window portions 740f and 740g, an operation window portion 740h and a setting portion 740k for setting rotation of the small second wheel 436. The guide window portion 740f of the train wheel setting lever 740 is guided by a guide pin 710p of the main plate 702. The guide window portion 740g of the train wheel setting lever 740 is guided by a guide pin 712p of the main plate 702. Therefore, the train wheel setting lever 740 is integrated to the main plate 702 to be able to move linearly relative to the main plate 702. According to the constitution shown in FIG. 24, the train wheel setting lever 740 is arranged not to overlap parts attached with hands, that is, the hour wheel 228, the center wheel & pinion for center 424, the small second wheel 436 and the ⅕ CG wheel 476. According to the constitution, the train wheel setting lever is arranged not to overlap the parts attached with the hands and therefore, the thickness of the electronic timepiece can be thinned.

When the hand setting stem is pulled to the first stage, the reset lever 730 is rotated and by rotating the operation spring 733, the train wheel setting lever 740 can be moved linearly along the surface of the main plat 702 by being guided by the guide pins 710p and 712p. When the train wheel setting lever 740 is moved linearly, the setting portion 740k of the train wheel setting lever 740 is brought into contact with the wheel portion 436d of the small second wheel 436, thereby, rotation of the small second wheel 436 can be set.

Rotation center of the reset lever 730 is arranged at the second region 320. Portions of the train wheel setting lever 740 and the reset lever 730 brought into contact with each other and the guide pin 710p are arranged at the first region 310. A portion of the setting portion 740k of the train wheel setting lever 740 which is brought into contact with the wheel portion 436d of the small second wheel 436 and the guide pin 712p are arranged at the fourth region 340.

The above-described constitutions of the first through the fourth types of the reset levers and the train wheel setting levers can be applied to the analog chronograph timepiece having the small second hand and can also be applied to an analog electronic timepiece having a small second hand which is not provided with a chronograph mechanism.

(4•5) Other Embodiment of Train Wheel Setting Lever

Although according to the above-described embodiments of the analog electronic timepieces of the invention, with regard to the constitutions of the reset levers and the train wheel setting levers of the first through the fourth types, an explanation has been given of the case in which rotation center of the small second wheel 436 is disposed at a position above the main plate reference horizontal axis line 304 and between the main plate center 300 and the outer shape portion 312 of the main plate disposed in “12 o'clock direction” of the movement, when rotation center of the small second wheel 436 is disposed at a position above the main plate reference horizontal axis line 304 and between the main plate center 300 and the outer shape portion 306 of the main plate disposed in “6 o'clock direction” of the movement, parts constituting the movement may be arranged to constitute a structure of mirror symmetry with the structures shown in FIG. 22 through FIG. 24 relative to the main plate reference vertical axis line 302.

That is, when rotation center of the small second wheel 436 is disposed at a position above the main plate reference horizontal axis line 304 and between the main plate center 300 and the outer shape portion 306 of the main plate disposed in “6 o'clock direction” of the movement, in the explanation with respect to the reset levers and the train wheel setting levers of the first through the fourth types, “first region 310” may be read to change to “second region 320”, “second region 320” may be read to change to “first region 310”, “third region 330” may be read to change to “fourth region 340” and “fourth region 340” may be read to change to “third region 330”.

According to the invention, in the analog electronic timepiece provided with the small second hand having the rotational center at a position other than the center of the movement, the small sized and thin analog electronic timepiece having the mechanism capable of firmly setting the train wheel for rotating the small second hand can be realized.

Further, according to the invention, in the analog electronic timepiece constituted to be able to arrange the chronograph second hand at the center of the movement and also capable of arranging the chronograph second hand at the position other than the center of the movement, in a structure of arranging the small second hand at the position other than the center of the movement, the small sized and thin analog electronic timepiece having the mechanism capable of firmly setting the train wheel for rotating the small second hand can be realized.

What is claimed is:

1. An analog electronic timepiece comprising:
a main plate constituting a base plate of a movement;
a bridge member for supporting a part constituting the movement;
a time information indicating wheel rotated with a main plate center of the main plate as a rotation center for indicating time information;
a small second wheel rotated with a position other than a center of the movement as a rotation center;
a hand setting stem for correcting to indicate the time information;
a switching apparatus for switching a position of the hand setting stem
a dial for indicating the time information;
a reset lever constituted to be able to rotate by operating the switching apparatus when the hand setting stem is pulled out from a zero stage to a first stage; and
a train wheel setting lever constituted to linearly move based on rotation of the reset lever when the hand setting stem is pulled out from the zero stage to the first stage, wherein the train wheel setting lever is constituted to be able to set rotation of the small second wheel or other wheel provided to rotate the small second wheel.

2. An analog electronic timepiece according to claim 1; wherein the train wheel setting lever is arranged not to overlap a part attached with a hand, that is, the time information indicating wheel and the small second wheel.

3. An analog electronic timepiece according to claim 1; wherein the train wheel setting lever is arranged to overlap the small second wheel.

4. An analog electronic timepiece according to claim 1; wherein the reset lever includes a reset conduction spring for carrying out a resetting operation, a train wheel setting lever holding portion for holding the train wheel setting lever and an operation spring for operating the train wheel setting lever.

5. An analog electronic timepiece according to claim 1; wherein a main plate reference vertical axis line passing the main plate center and in parallel with a center axis line of the hand setting stem and a main plate reference horizontal axis line passing the main plate center and orthogonal to the main plate reference vertical axis line are defined at the main plate;
wherein the main plate is provided with a first region disposed on one side of the main plate reference vertical axis line and on a side of the main plate reference horizontal axis line proximate to the hand setting stem, the main plate is provided with a second region disposed on other side of the main plate reference vertical axis line and on the side of the main plate reference horizontal axis line proximate to the hand setting stem, the main plate is provided with a third region disposed on the other side of the main plate reference vertical axis line on which the second region is present and on a side of the main plate reference horizontal axis line remote from the hand setting stem and the main plate is provided with a fourth region disposed on the one side of the main plate reference vertical axis line on which the first region is present and on the side of the main plate reference horizontal axis line remote from the hand setting stem;
wherein a rotation center of the small second wheel is arranged at a position above the main plate reference horizontal axis line, above a boundary between the first region and the fourth region and between the main plate center and an outer shape portion of the main plate;
wherein a rotation center of the reset lever is arranged at the second region;
wherein portions of the train wheel setting lever and the reset lever which are brought into contact with each other are arranged at the first region; and
wherein a portion of a setting portion of the train wheel setting lever to be brought into contact with a wheel to be set is arranged at the fourth region.

6. An analog electronic timepiece according to claim 1; wherein the train wheel setting lever includes two of guide window portions, the main plate includes two of guide pins for guiding the train wheel setting lever, the guide window portions of the train wheel setting lever are respectively constituted to be guided by the guide pins of the main plate, the train wheel setting lever is integrated to the main plate to be able to move linearly relative to the main plate and one of the guide pins is arranged at the first region and other thereof is arranged at the fourth region.

7. An analog chronograph timepiece comprising;
a main plate constituting a base plate of a movement;
a bridge member for supporting a part constituting the movement;
a time information indicating wheel rotated with a main plate center of the main plate as a rotation center for indicating time information;
a hand setting stem for correcting to indicate the time information;
a switching apparatus for switching a position of the hand setting stem; and
a dial for indicating the time information;
wherein the main plate includes bearing portions of a rotor and a train wheel used for fabricating a “center chronograph timepiece” by using the movement and bearing portions of a rotor and a train wheel used in fabricating a “side chronograph timepiece” by using the movement;
wherein the bridge member includes bearing portions of the rotor and the train wheel used in fabricating the “center chronograph timepiece” by using the movement and bearing portions of the rotor and the train wheel used in fabricating the “side chronograph timepiece” by using the movement;
wherein the rotor and the train wheel used in fabricating the “center chronograph timepiece” are integrated to be able to rotate relative to the bearing portions of the main plate and the bearing portions of the bridge member;
wherein the time information is constituted to indicate by a time indicating member rotated with the main plate center as a rotation center and other time indicating member rotated with a position between the main plate center and an outer shape portion of the main plate as a rotation center;
wherein a measurement result of a chronograph is constituted to indicate by a chronograph indicating member rotated with the main plate center as a rotation center and other chronograph indicating member rotated with a position between the main plate center and the outer shape portion of the main plate as a rotation center;
a reset lever constituted to be able to rotate by operating the switching apparatus when the hand setting stem is pulled out from a zero stage to a first stage; and
a train wheel setting lever constituted to move linearly based on rotation of the reset lever when the hand setting stem is pulled out from the zero stage to the first stage;
wherein the train wheel setting lever is constituted to be able to set rotation of a wheel in a train wheel provided for rotating the other time indicating member.

8. An analog electronic timepiece according to claim 7, wherein a main plate reference vertical axis line passing the main plate center and in parallel with a center axis line of the hand setting stem and a main plate reference horizontal axis line passing the main plate center and orthogonal to the main plate reference vertical axis line are defined at the main plate;
wherein the main plate is provided with a first region disposed on one side of the main plate reference vertical axis line and on a side of the main plate reference horizontal axis line proximate to the hand setting stem, the main plate is provided with a second region disposed on other side of the main plate reference vertical axis line and on the side of the main plate reference horizontal axis line proximate to the hand setting stem, the main plate is provided with a third region disposed on the other side of the main plate reference vertical axis line on which the second region is present and on a side of the main plate reference horizontal axis line remote from the hand setting stem and the main plate is provided with a fourth region disposed on the one side of the main plate reference vertical axis line on which the first region is present and on the side of the main plate reference horizontal axis line remote from the hand setting stem;
wherein a rotation center of the other time indicating member is arranged at a position above the main plate reference horizontal axis line, above a boundary between the first region and the fourth region and between the main plate center and an outer shape portion of the main plate;
wherein a rotation center of the reset lever is arranged at the second region;
wherein portions of the train wheel setting lever and the reset lever which are brought into contact with each other are arranged at the first region; and
wherein a portion of a setting portion of the train wheel setting lever to be brought into contact with a wheel to be set is arranged at the fourth region.

9. An analog electronic timepiece according to claim 7; wherein the train wheel setting lever includes two of guide window portions, the main plate includes two of guide pins for guiding the train wheel setting lever, the guide window portions of the train wheel setting lever are respectively constituted to be guided by the guide pins of the main plate, the train wheel setting lever is integrated to the main plate to be able to move linearly relative to the main plate and one of the guide pins is arranged at the first region and other thereof is arranged at the fourth region.
